(19) United States
(12) Patent Application Publication
(10) Pub. No.: US 2016/0236409 A1
(43) Pub. Date: Aug. 18, 2016

(54) 3D PRINTER

(71) Applicants: Michael Daniel Armani, Bethesda, MD (US); David Souza Jones, Burtonsville, MD (US)

(72) Inventors: Michael Daniel Armani, Bethesda, MD (US); David Souza Jones, Burtonsville, MD (US)

(21) Appl. No.: 14/840,361

(22) Filed: Aug. 31, 2015

Related U.S. Application Data
(60) Provisional application No. 62/117,439, filed on Feb. 17, 2015.

(51) Int. Cl. B29C 67/00; B29C 47/12

(52) U.S. Cl. CPC B29C 67/0059; B29C 67/0088; B29C 47/12; B29K 2105/0058

(57) ABSTRACT

A 3D printer has a casing, a nozzle for printing, an extruder, a heating element, and a print bed. The casing encloses a region above and around the print bed to form a printing zone. Further, the 3D printer has features adapted for low-noise operation, and is already suitably quiet enough for use in a low-noise environment because it does not generate loud sounds. Specifically, in a quiet office with 37-38 dB of noise, noise emissions were measured while the present invention constructed a 3D printed model, and at six inches from the extruder on the 3D printer, the noise emissions measured 39-58 dB, at three feet away measured 38-43 dB, and at six feet away measured around 37-40 dB.

### CROSS REFERENCE TO RELATED APPLICATIONS

This application claims the priority of Provisional Application No. 62/117,439 filed on Feb. 17, 2015, inventors Michael Daniel Armani and David Souza Jones, entitled “3D Printer”. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to 3D printers, and particularly to 3D printers which have improved space efficiency, improved energy efficiency, improved precision, improved safety, improved motors for 3D printers, and improved cost effectiveness.

### BACKGROUND OF THE INVENTION

It is a problem in the art to provide a 3D printer which has improved space efficiency, improved energy efficiency, improved precision, reduced noise emissions, improved safety, improved motors for 3D printers, and/or improved cost effectiveness.

Further, it is also a problem in the art to provide an improved modeling filament supply and/or novel modeling filament materials for use in 3D printing technology.

It is furthermore a problem in the art to provide an improved system and method for 3D printing, which results in improved space efficiency, improved energy efficiency, improved precision, reduced noise emissions, improved safety, improved motors for 3D printers, and/or improved cost effectiveness.

The present invention is directed to the form, function, and methods of use of a 3D printer and related mechanical designs, motion systems, motor technologies, backlash compensation techniques, computer software, electronics, microcontrollers, and consumable plastic filaments. As of the time of writing, there are several hundred models of commercially available 3D printers available or previously released on the market. These printers are generally categorized as being based on filament (extrusion) deposition, layered powder sintering, stereo lithography, laminated model manufacturing, and similar technologies as is known in the art.

### SUMMARY OF THE INVENTION

From the foregoing, it is seen that it is a problem in the art to provide a device, system, and/or method meeting the above requirements. According to the present invention, a device, system, and method is provided which meets the aforementioned requirements and needs in the prior art. Specifically, the device according to the present invention provides a device for 3D printing having improved space efficiency, improved energy efficiency, improved precision, reduced noise emissions, improved safety, improved motors for 3D printers, and/or improved cost effectiveness.

The device of the present invention provides an exemplary embodiment that is based on the reduction to practice of a filament extrusion based 3D printer.

Additionally, no 3D printers currently exist or have existed on the market which employ a positioning system based on micro stepper motors using gear reduction technology. As will be explained further hereunder, the existing art teaches away from using such micro reduction stepper motor due to limitations regarding speed, torque, and backlash. These motors are sometimes referred to as “uni-directional” motors because of the great degree of backlash, and they are most often limited to low-speed applications. By the present invention, a 3D printer technology is shown and described that employs micro reduction stepper motors in a manner that nearly eliminates backlash in the positioning system movement, and improves the speed and torque characteristics. As a result, the present invention shows a novel and useful 3D printer.

Furthermore, it will be appreciated by anyone skilled in the art that many of the techniques employed such as new motor technologies, user software, and backlash compensation methods can be applied to all 3D printing technologies. Therefore these inventive techniques are not limited to filament-based 3D printers. In addition, one skilled in the art will appreciate that the motor technologies, electronics for faster motor driving, the use of micro motors with gearing, and backlash compensation technologies can be applied to micro positioning systems, stages, inkjet printers, scanner/rastering systems, robots, IP cameras, paper feeders, air conditioner louvers, fluid dispensers, electronic pill box, and automation technologies in general.

Therefore, the various aspects of the present invention as shown and described hereunder have applicability to a wider field of use beyond limited 3D printers.

Other objects and advantages of the present invention will be more readily apparent from the following detailed description when read in conjunction with the accompanying drawings.

### BRIEF DESCRIPTION OF THE DRAWINGS

FIG. 1 is a front perspective view illustrating an assembled 3D printer according to the invention.

FIG. 2 is a back perspective view illustrating an assembled 3D printer according to the invention.

FIG. 3 is a front view illustrating a 3D printer assembly according to the invention.

FIG. 4 is a side view illustrating a 3D printer assembly according to the invention.

FIG. 5 is a back view illustrating a 3D printer assembly according to the invention.

FIG. 6 is a top view illustrating a 3D printer assembly according to the invention.

FIG. 7 is a bottom view illustrating a 3D printer assembly according to the invention.

FIG. 8 is a front perspective exploded view illustrating the parts of a 3D printer assembly according to the invention, wherein wires for the PCB, motors, and lights are not shown.

FIG. 9 is a rear perspective exploded view illustrating the parts of a 3D printer assembly according to the invention, wherein wires for the PCB, motors, and lights are not shown.

FIG. 10 is an exploded view illustrating the parts of a lower gantry assembly installed on the base frame according to the invention, wherein wires for the PCB, motors, and lights are not shown.

FIG. 11 is a front perspective view illustrating a 3D printer with the top frame and extruder covers removed, wherein wires for the PCB, motors, and lights are not shown.

FIG. 12 is a rear perspective view illustrating a 3D printer with the top frame and extruder covers removed, wherein wires for the PCB, motors, and lights are not shown.

FIG. 13 is a perspective view illustrating a lower gantry assembly installed on the base frame according to the invention, wherein wires for the PCB, motors, and lights are not shown.

FIG. 14 is an upside-down rear perspective partial exploded view illustrating an extruder assembly according to the invention, wherein wires for the PCB, motors, and fan are not shown.

FIG. 15 is a front perspective partial exploded view illustrating an extruder assembly according to the invention, wherein wires for the PCB, motors, and fan are not shown.

FIG. 16 is an exploded view illustrating the parts of an extruder assembly according to the invention, wherein wires for the PCB, motors, and fan are not shown.

FIG. 17 is a perspective view illustrating a top gantry assembly according to the invention.

FIG. 18 is an exploded view illustrating the parts of a top gantry assembly according to the invention.

FIG. 19 shows a front-facing section cut conceptual view of the filament material flow path within the extruder, wherein wires for the PCB, motors, and fan are not shown.

FIG. 20 shows a perspective view of injection moldable features on the 3D printer base frame and internal body frame, wherein wires for the PCB, motors, and lights are not shown.

FIG. 21 shows a perspective view section cut of injection moldable features on the 3D printer top frame and base frame.

FIG. 22 shows a perspective view of a pulley which has two protrusions for connecting to bearings, and a cut through one side from top to bottom to provide flexibility.

FIG. 23 shows a top view of a pulley which has two protrusions for connecting to bearings, and a cut through one side from top to bottom to provide flexibility.

FIG. 24 shows a perspective view of a first embodiment of a nozzle that can be used with a low-power heater according to the invention.

FIG. 25 shows a perspective view of a second embodiment of a nozzle that can be used with a low-power heater according to the invention.

### DETAILED DESCRIPTION OF THE INVENTION

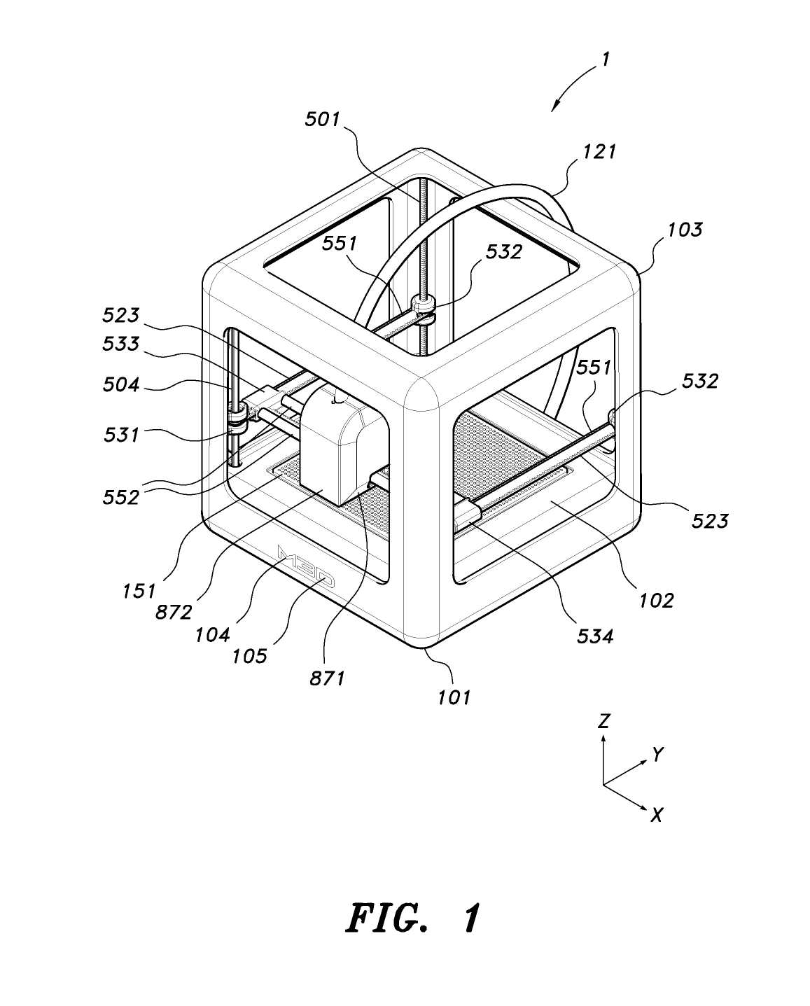

The device of the present invention as shown in FIGS. 1-25 relates to an apparatus 1 for 3D printing, having improved space efficiency, improved energy efficiency, improved precision, reduced noise emissions, improved safety, improved motors for 3D printers, and improved cost effectiveness.

FIG. 1 is a front perspective view illustrating an assembled 3D printer 1.

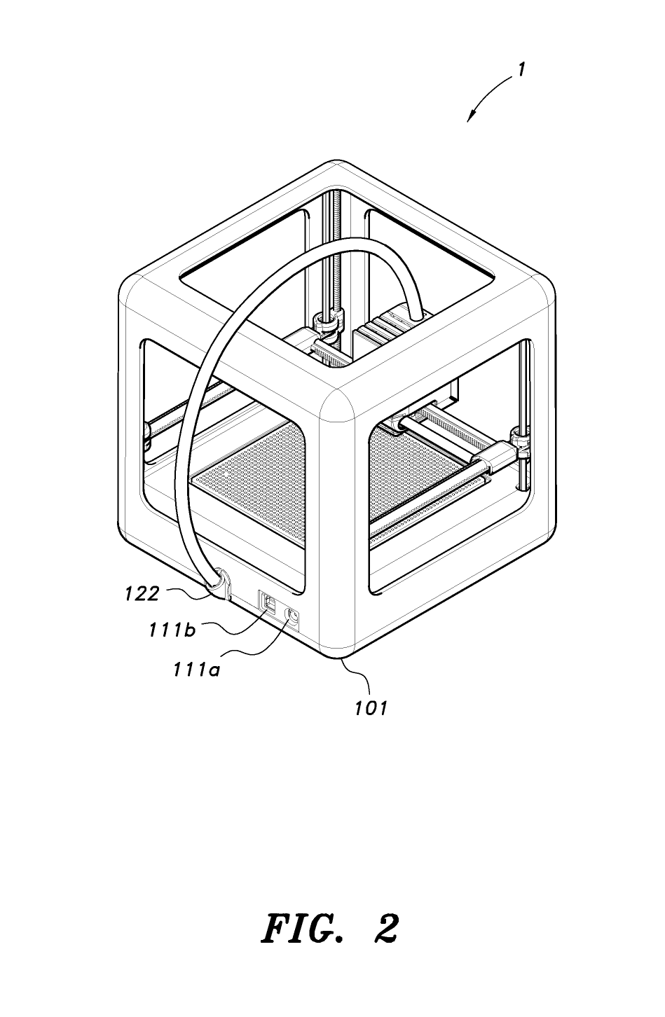

FIG. 2 is a back perspective view illustrating an assembled 3D printer 1.

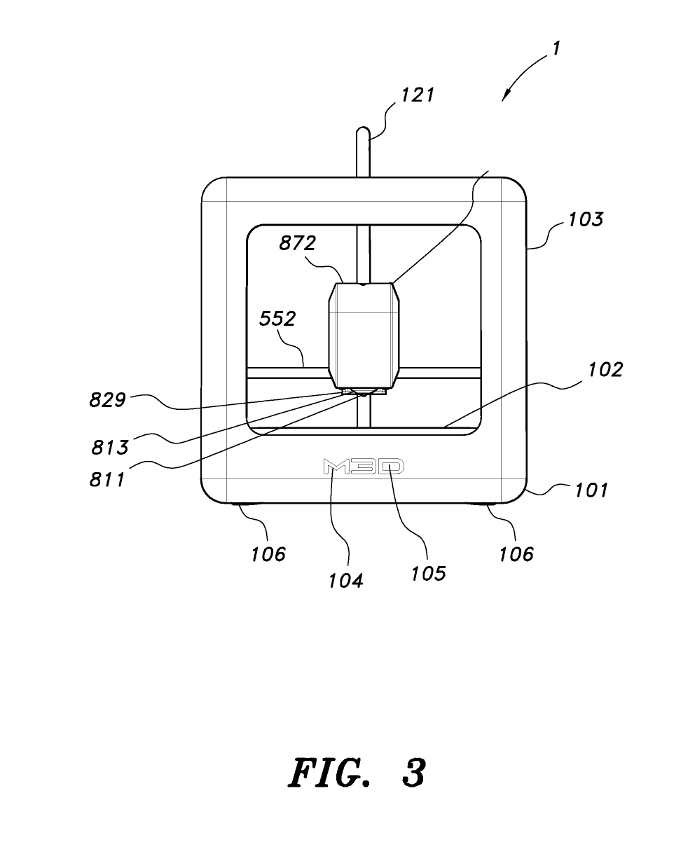

FIG. 3 is a front view illustrating a 3D printer assembly.

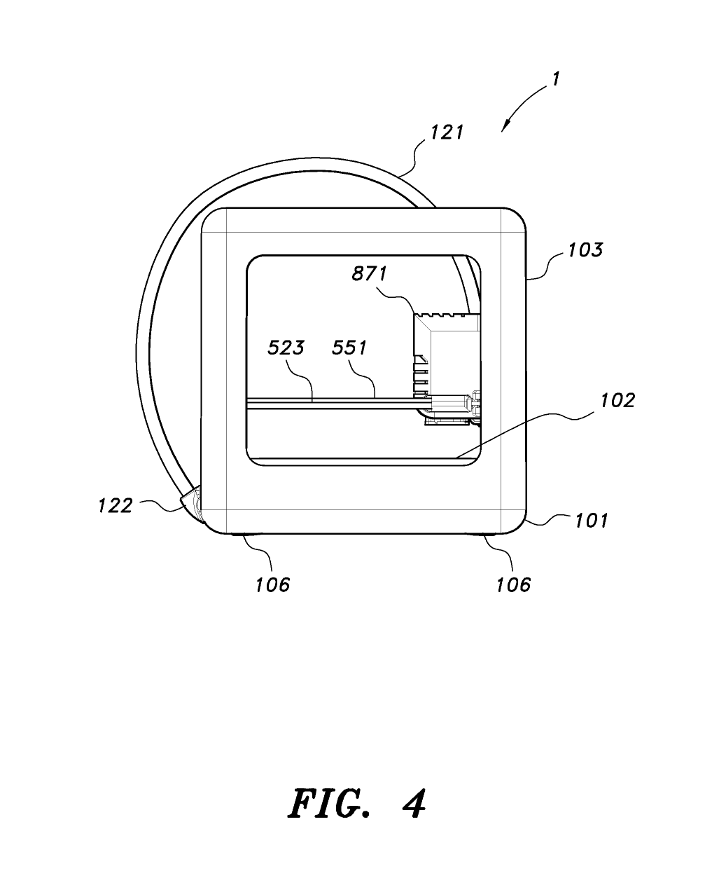

FIG. 4 is a side view illustrating a 3D printer assembly.

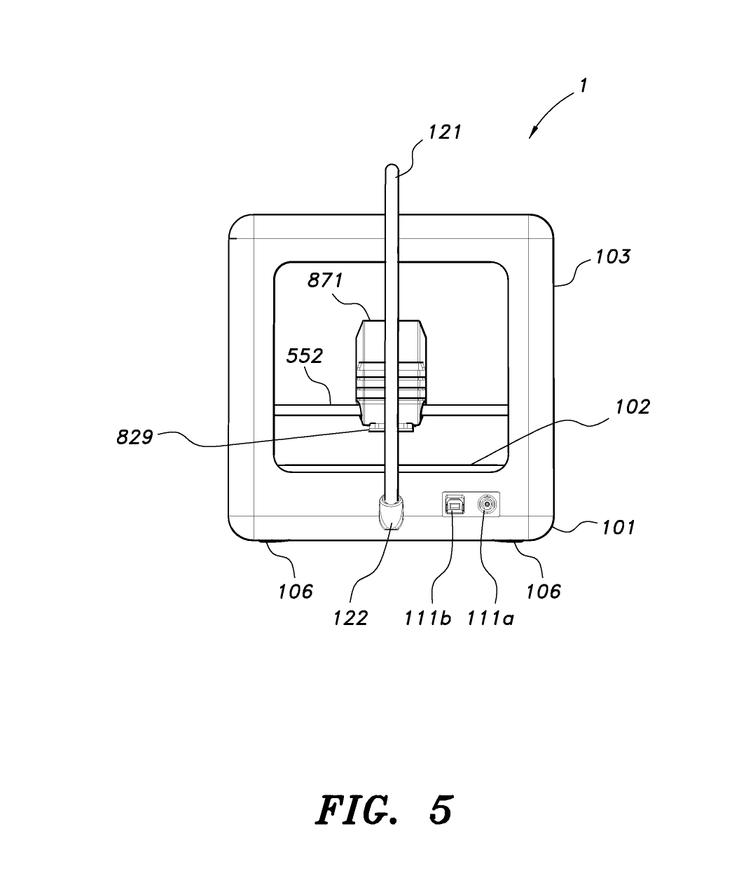

FIG. 5 is a back view illustrating a 3D printer assembly.

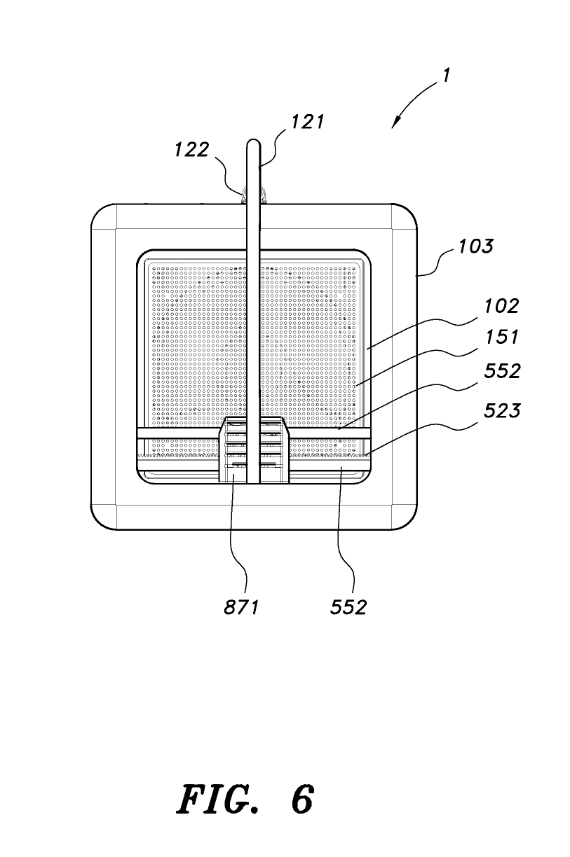

FIG. 6 is a top view illustrating a 3D printer assembly.

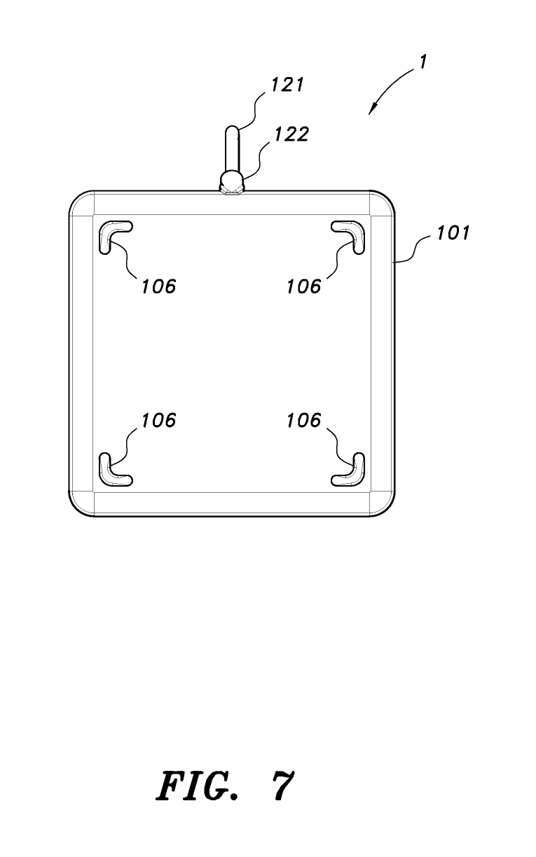

FIG. 7 is a bottom view illustrating a 3D printer assembly.

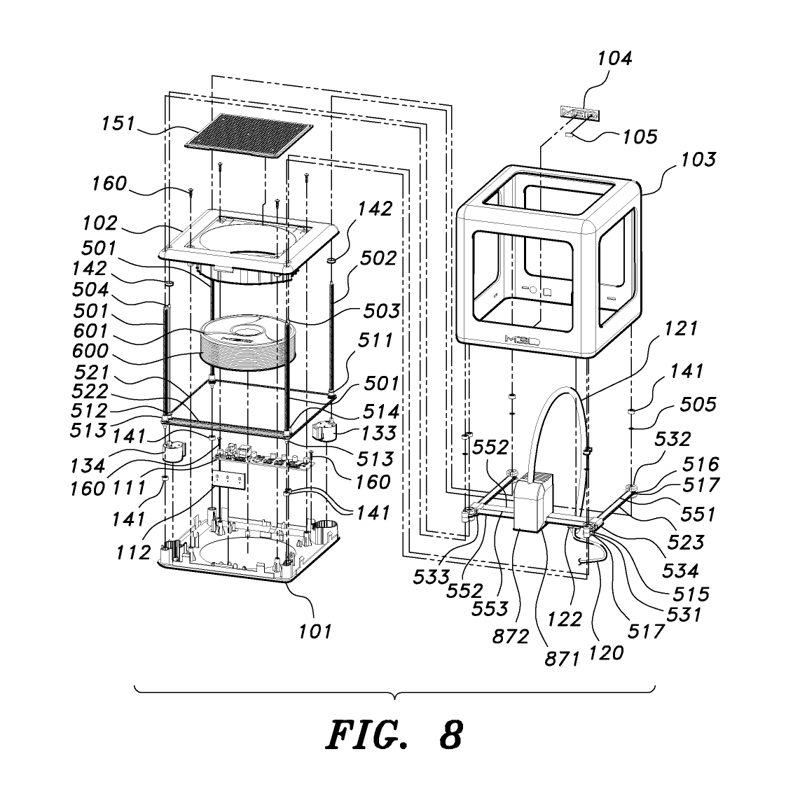

FIG. 8 is a front perspective exploded view illustrating the parts of a 3D printer assembly according to FIGS. 1-7, wherein wires for the PCB, motors, and lights are not shown.

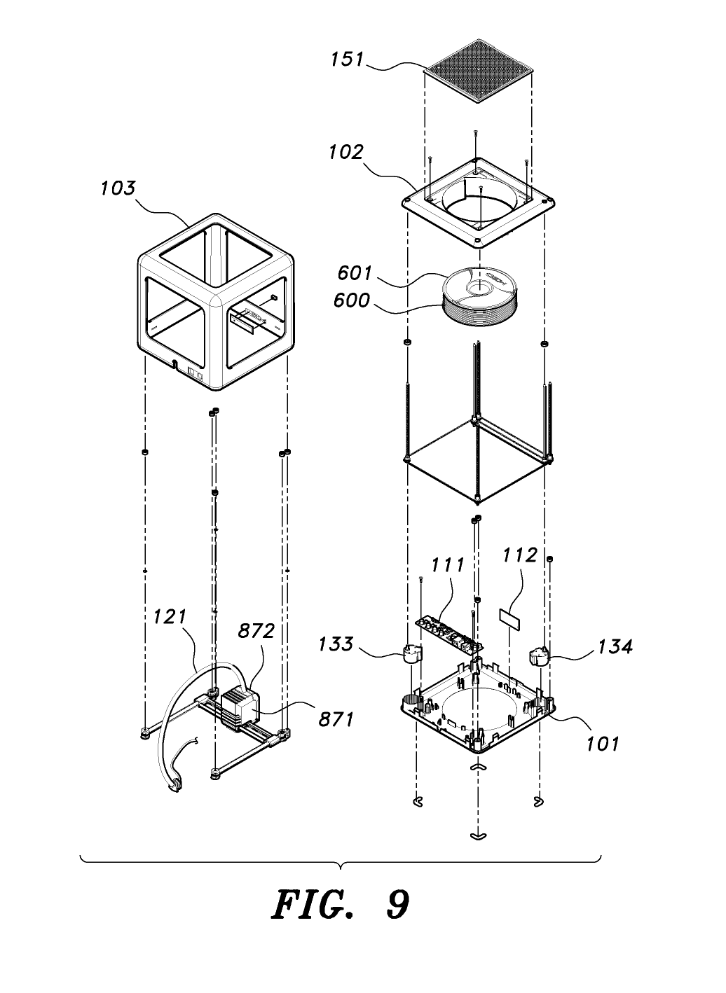

FIG. 9 is a rear perspective exploded view illustrating the parts of a 3D printer assembly according to FIGS. 1-7, wherein wires for the PCB, motors, and lights are not shown.

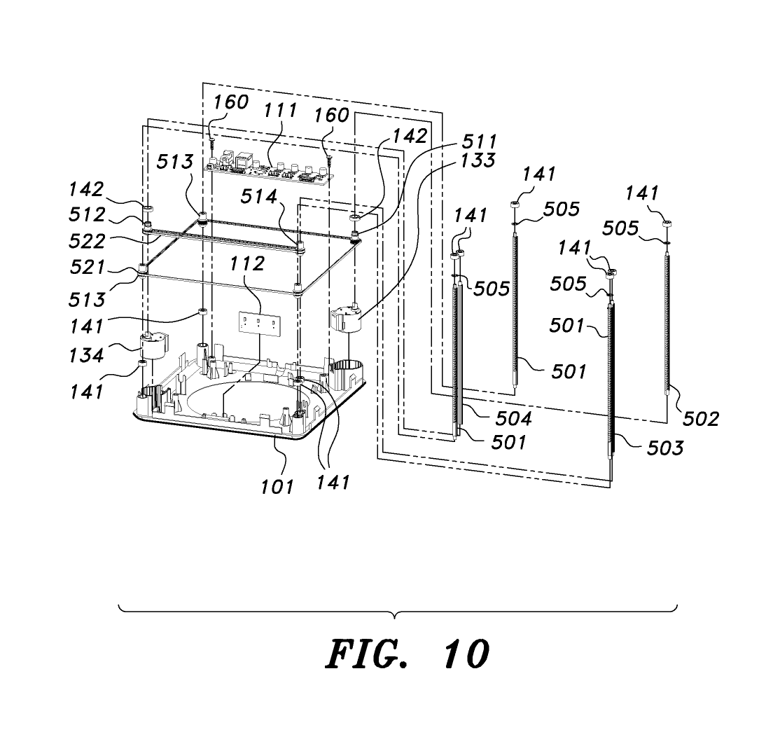

FIG. 10 is an exploded view illustrating the parts of a lower gantry assembly installed on a base frame, wherein wires for the PCB, motors, and lights are not shown.

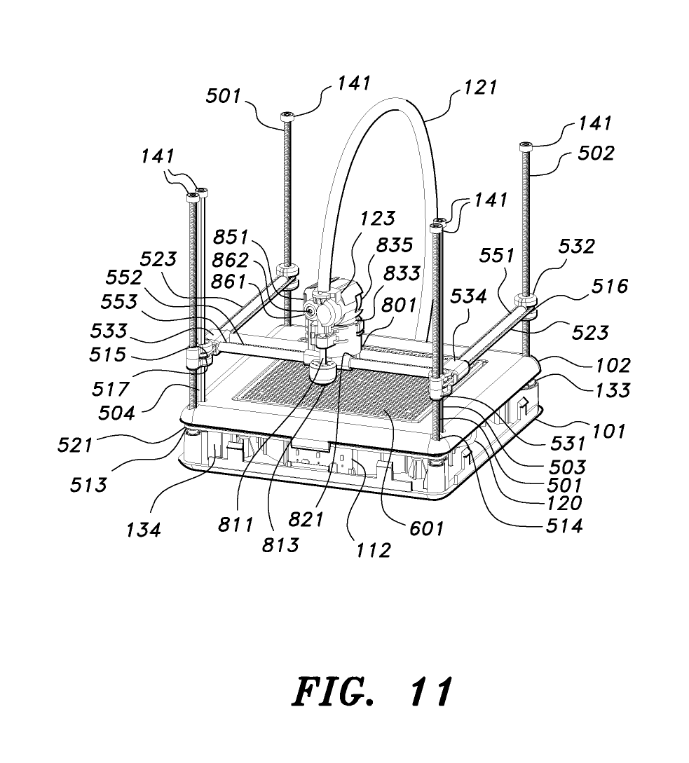

FIG. 11 is a front perspective view illustrating a 3D printer according to FIGS. 1-10, with the top frame and extruder covers removed, and wherein wires for the PCB, motors, and lights are not shown.

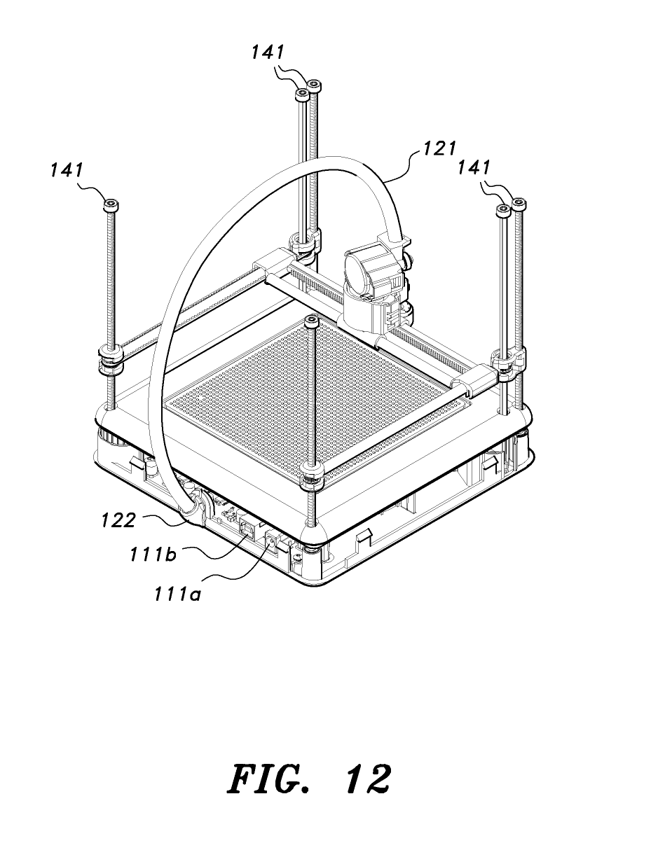

FIG. 12 is a rear perspective view illustrating a 3D printer with the top frame and extruder covers removed, wherein wires for the PCB, motors, and lights are not shown.

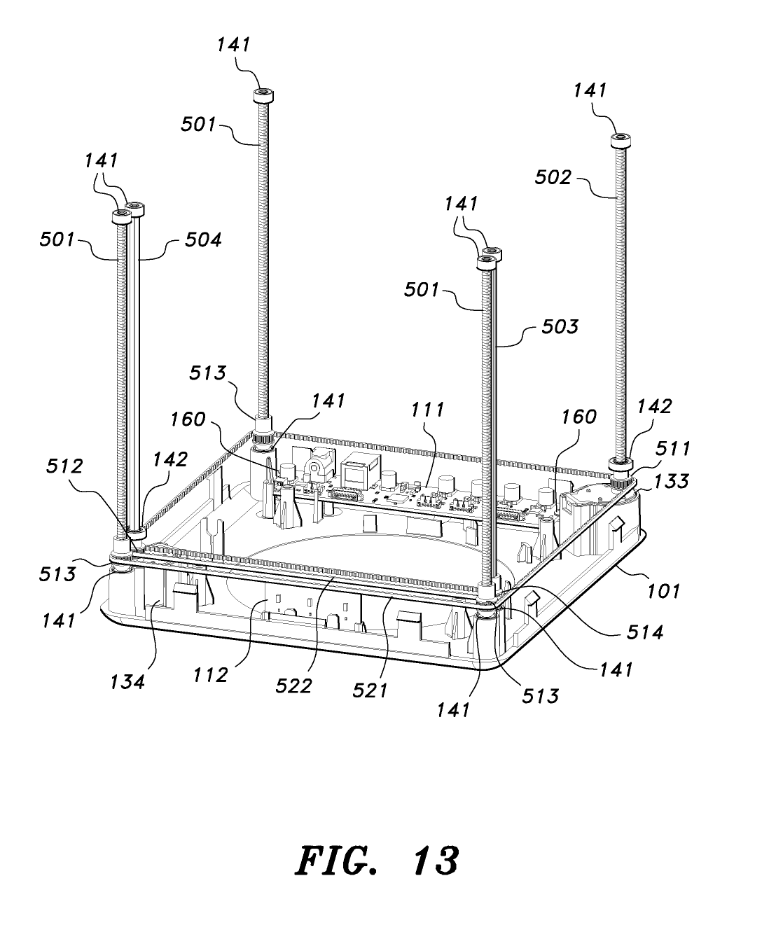

FIG. 13 is a perspective view illustrating a lower gantry assembly installed on the base frame, wherein wires for the PCB, motors, and lights are not shown.

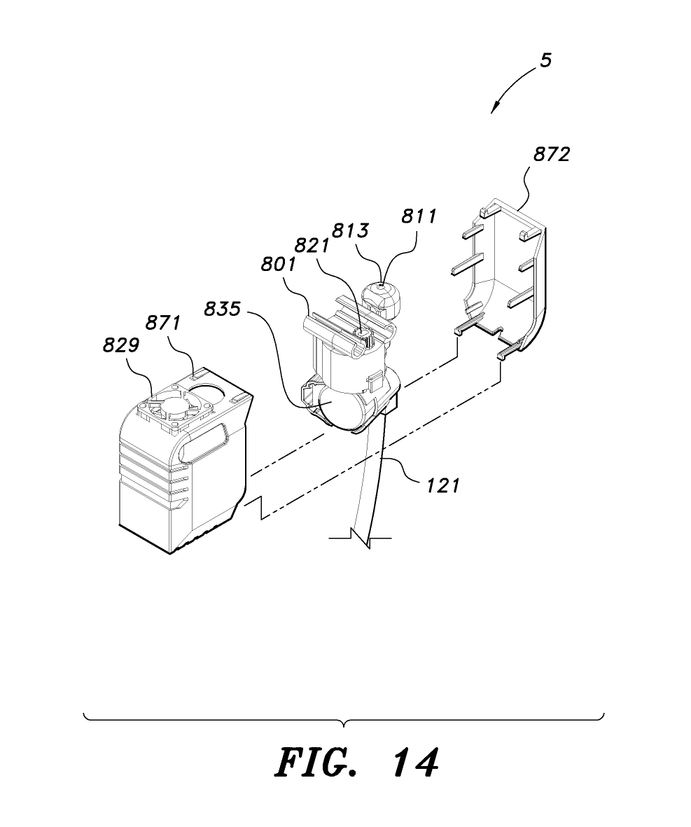

FIG. 14 is an upside-down rear perspective partial exploded view illustrating an extruder assembly, wherein wires for the PCB, motors, and fan are not shown.

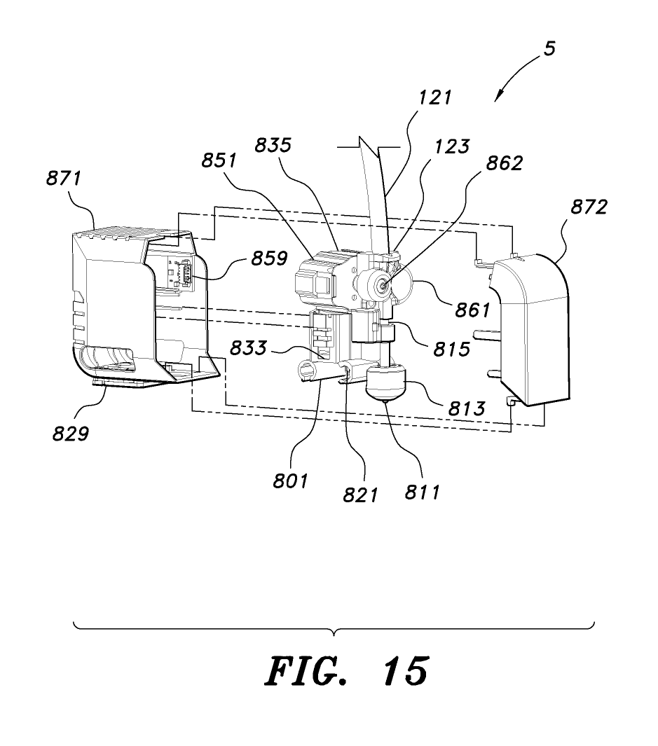

FIG. 15 is a front perspective partial exploded view illustrating the extruder assembly of FIG. 14, wherein wires for the PCB, motors, and fan are not shown.

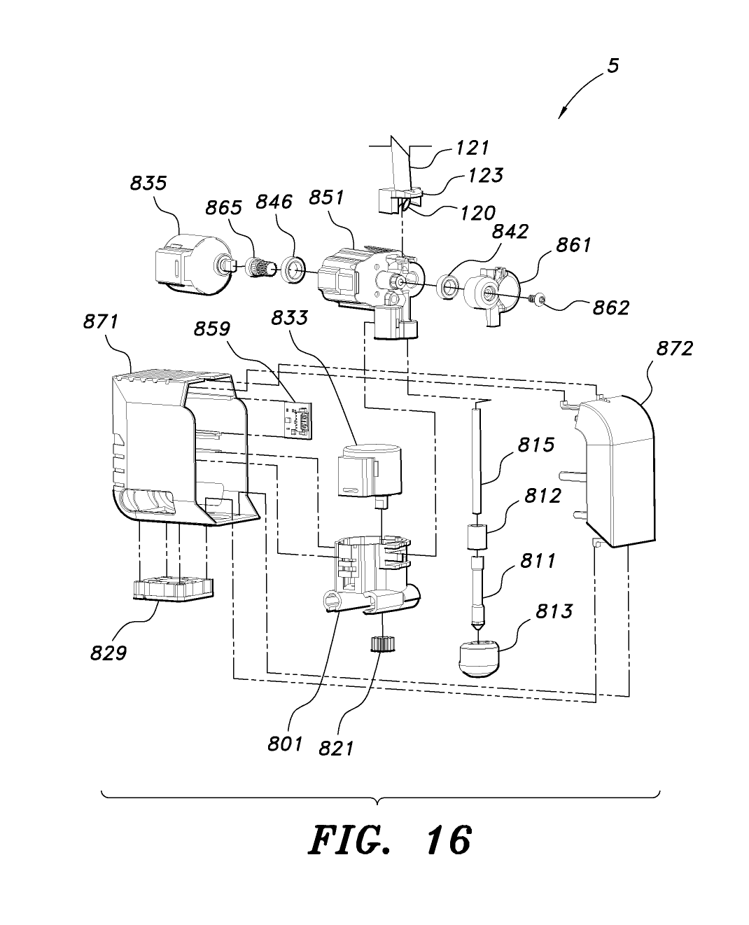

FIG. 16 is an exploded view illustrating the parts of the extruder assembly, wherein wires for the PCB, motors, and fan are not shown.

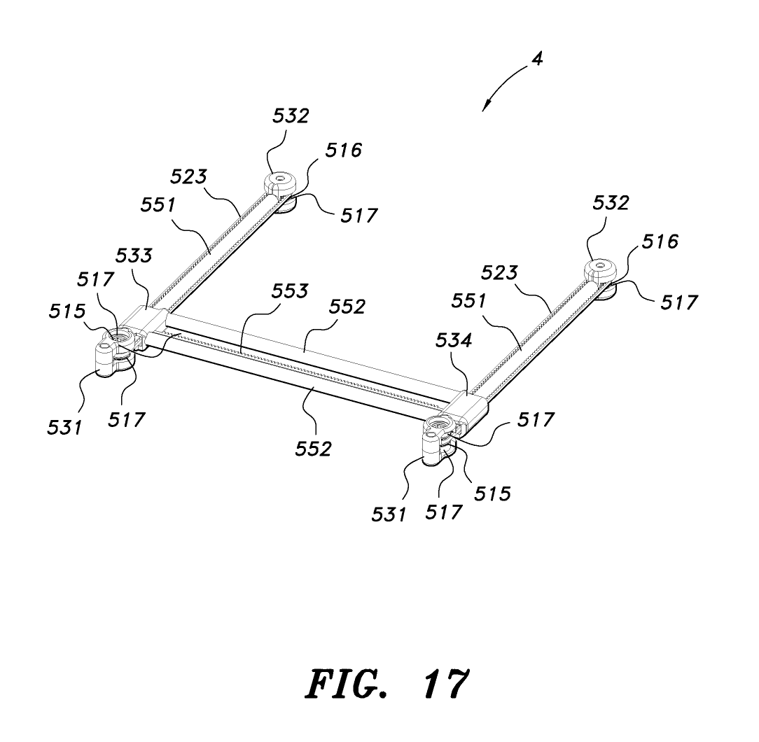

FIG. 17 is a perspective view illustrating a top gantry assembly.

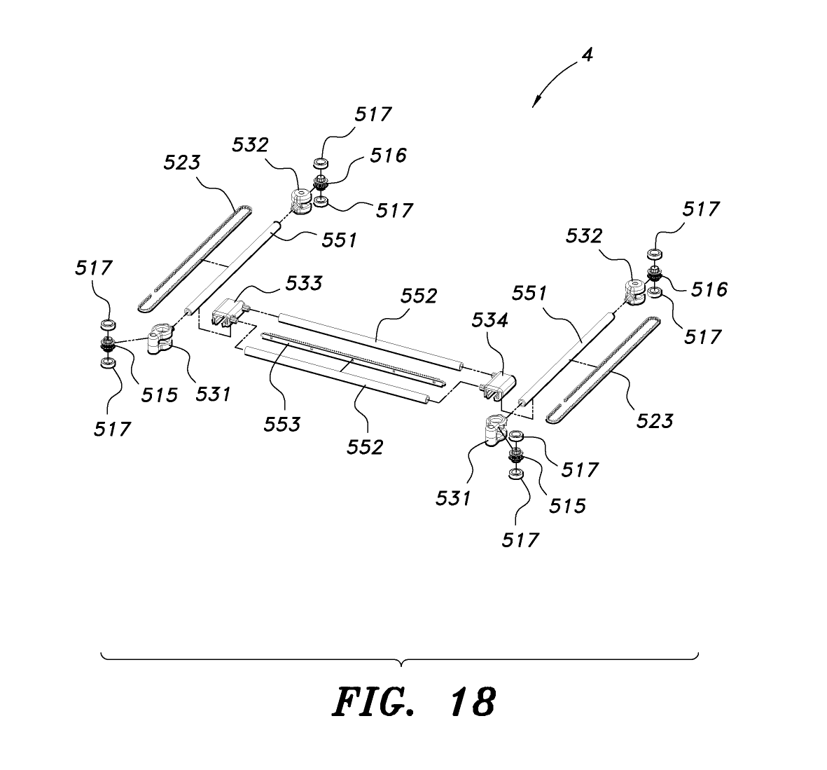

FIG. 18 is an exploded view illustrating the parts of a top gantry assembly.

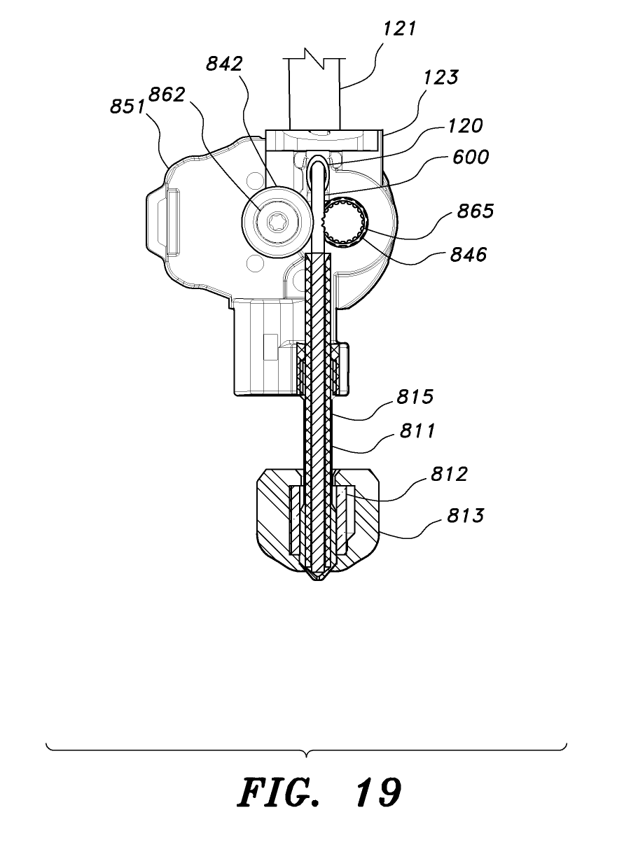

FIG. 19 shows a front-facing section cut conceptual view of the filament material flow path within the extruder, wherein wires for the PCB, motors, and fan are not shown.

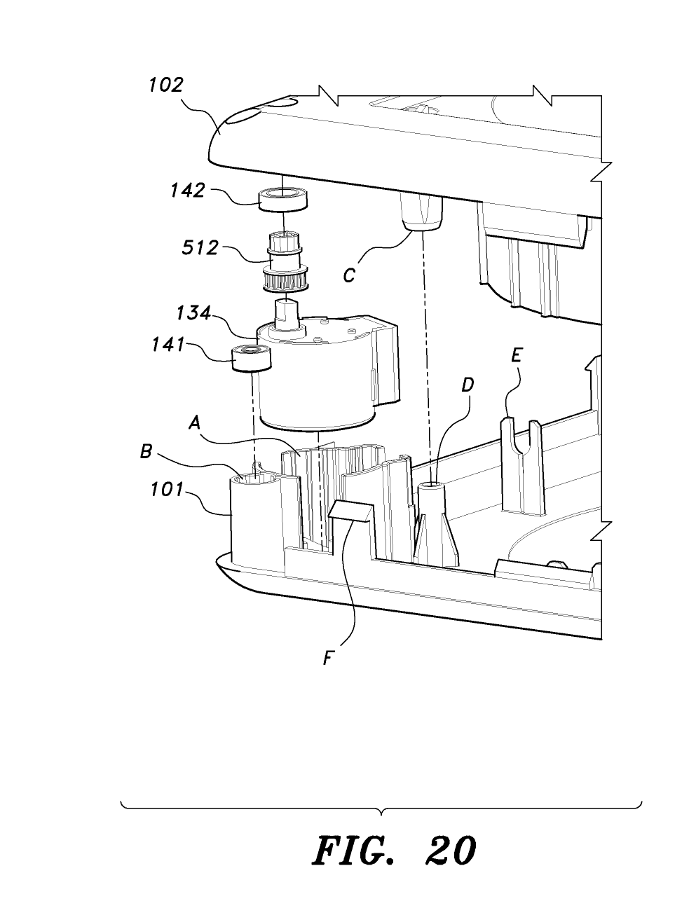

FIG. 20 shows a perspective view of injection moldable features on the 3D printer base frame and internal body frame, wherein wires for the PCB, motors, and lights are not shown.

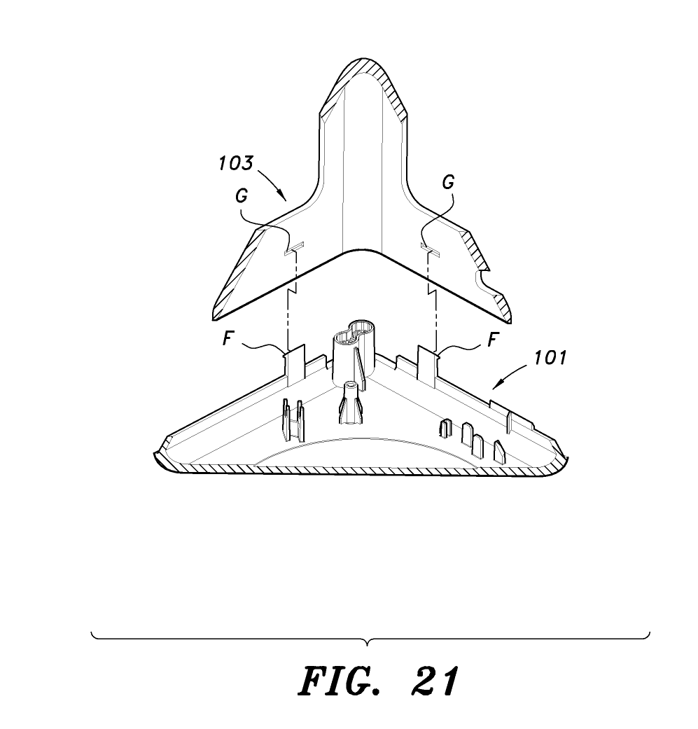

FIG. 21 shows a perspective view section cut of injection moldable features on the 3D printer top frame and base frame.

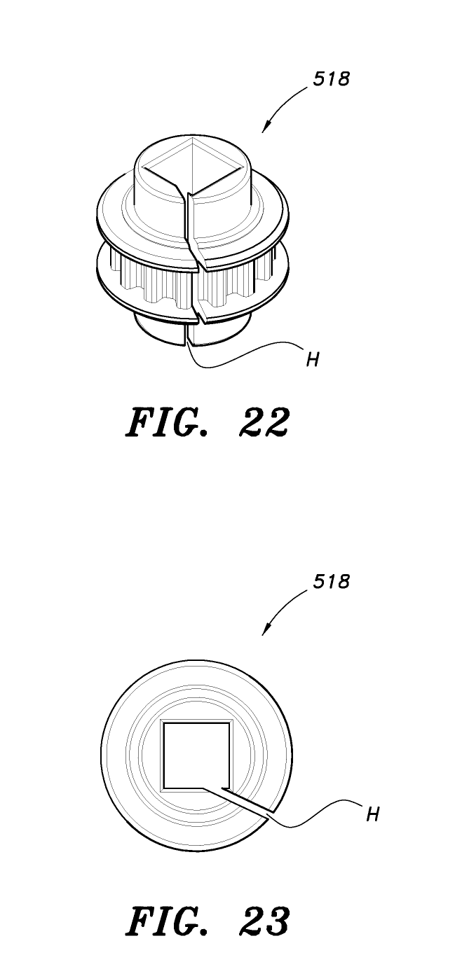

FIG. 22 shows a perspective view of a pulley which has two protrusions for connecting to bearings, and a cut through one side from top to bottom to provide flexibility.

FIG. 23 shows a top view of a pulley which has two protrusions for connecting to bearings, and a cut through one side from top to bottom to provide flexibility.

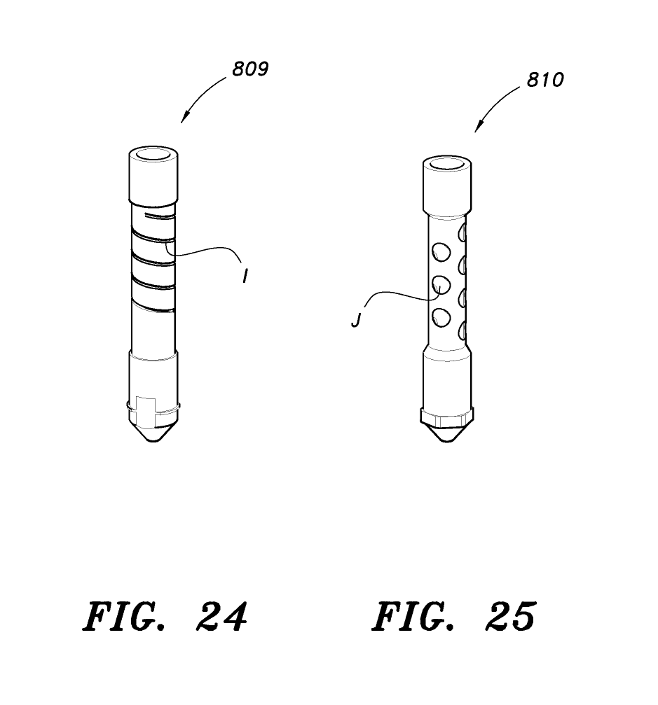

FIG. 24 shows a perspective view of a first embodiment of a nozzle that can be used with a low-power heater.

FIG. 25 shows a perspective view of a second embodiment of a nozzle that can be used with a low-power heater.

### General Function of the Invention

The overall object of the invention to provide a construction for a 3D printer 1 which can produce a 3D printed model. Referring to FIGS. 1-8, to achieve a 3D printed model using the 3D printer of the present invention, plastic filament 600 provided in cord form or on filament roll 601 is unrolled by a user, from an internal or external rotational support. The user pulls the filament roll 601 and subsequently pushing it through a tube 120 inside the cable assembly 121 connected to the 3D printing enclosure. A major portion of the tube 120 is inside the braided cover of cable assembly 121. Cable grommet 122 protects and guides cable assembly 121 at the base frame of the printer. As the filament 600 is pulled the filament roll 601 rotates to release tension on the filament. By pushing the filament 600 through a tube 120, the filament is guided up the tube. The filament 600 eventually passes inside the extruder body cover 871 and reaches the extruder gear 865 shown in FIG. 19. At this stage the 3D printer extruder motor takes over pulling of the filament 600 and the user does not have to intervene except to ensure that it is being pulled by motor through software interaction.

Now referring to FIG. 19, the filament 600 is compressed between the extruder gear 865 and filament bearing 842 to provide friction for the pulling action. In addition, the extruder gear 865, which is driven by motorE 835, has knurling to cut and/or hobbing to guide the filament while providing grip for pulling and pushing the filament. The extruder motor's speed is metered to control the rate of filament movement as it passes through the extruder system. As the filament is pushed by the extruder motor it moves into a nozzle 811 that has an internal nozzle tube 815 inside to reduce friction and relieve excessive internal pressure. A heating element 812 provides heat to the nozzle 811 and subsequently, the internal nozzle tube 815, and the filament 600. The electronic control board 111 sets heating element 812 to predetermined temperature(s). The electronic control board 111 also provides temperature control of the heating element 812 by feedback sensing through only two wires in total (not shown in figures). As a result, heat conducts into the filament, turning the plastic into a molten state. The pressure from the non-molten filament above it forces the molten filament to flow through a nozzle orifice. Therefore, as a result of the filament movement speed control, molten plastic extrusion can be controlled at a proportionate rate. The filament or “plastic” may also comprise any other thermally formable material, such as thermoplastic elastomer, metal alloys, or particle-filled plastics, and it not limited only to classic feedstocks or modeling filaments such as ABS plastic.

Now referring to FIGS. 11 and 16, A 3D printed model is then generated by depositing the molten extrusion across a 2D layer in the XY plane, and then by performing a multitude of iterative layered extrusions in the Z direction. The XY motion is generated by a motorX 833 which provides X-axis motion with a rack 553 and pinion gear 821 system, and a motorY 134 which provides motion through a belt and gear train, resulting in Y motion to two sides of a gantry. The Z motion is generated by a motorZ 133 which rotates motorZ rod 502 and three Z rods 501 that move the entire gantry.

These motors are driven by power and signals generated on the electronic control board 111 which contains a microcontroller. The microcontroller controls the motors according to a signal sent by a computer over a USB cable. The computer controls the extrusion along the XYZ path according to a predetermined motion control script.

Through the use of data from sensor 859 or another sensor (such as a capacitance displacement sensor, or an optical linear encoder) attached to the X guide rods 552 and/or Y guide rods 551, this motion control script could be modified mid-print so the printer's movement is self-correcting.

The present invention includes novel compositions, methods of manufacture, and methods of use, to improve 3D printers towards the major object of the invention, which is to allow for a low-cost consumer 3D printer. This can partially be achieved by using a combination of low-power (or no-power) and/or loose-tolerance components. When “loose-tolerance” is used, it means parts or components with a large standard deviation in batch-to-batch measurements; for example, a shaft with 0.1 mm dimensional consistency is a loose-tolerance shaft, whereas a 0.025 mm shaft consistency is tight-tolerance and requires a more accurate counterpart mate. Often, the loose-tolerance design is considered less expensive. Inclusion of design features that are novel in the art of 3D printers allow for such tolerances to be used, without sacrificing performance.

### Detailed Description of the Preferred Embodiments

### Rigid Frame Design

FIG. 3 illustrates a front view of an assembled 3D printer 1, which is a preferred embodiment according to the invention. The 3D printer 1 comprises a base frame 101 which is coupled to a top frame 103 and an internal body frame 102. Logo plate 104 is press-fitted into the side wall of top frame 103. A logo plate insert 105 is fitted or glued into the logo plate 104.

Base frame 101 contains four base feet 106 which provides the base platform for the printer to rest on another surface such as a computer table. Base frame 101 provides internal supports for holding motors, electronics, lights, wires, cables, and a filament roll 601 as described throughout this specification. FIG. 20 illustrates an injection-molded wire guide E. Top frame 103 provides a large, single, seamless external product cover, and in combination with base frame 101 and internal body frame 102 provides a rigid support for the upper gantry assembly 4 seen in FIG. 17. Internal body frame 102 provides support for holding the removable print bed 151 as shown in FIG. 8, on which the 3D printed part is produced. Base frame 101, internal body frame 102, and top frame 103 are preferably designed in accordance with US design patent application number 29/469,491 filed Oct. 10, 2013 for a “Three-Dimensional Printer Frame,” which is owned by the inventors and incorporated by reference herein.

It is an important object of the present invention to provide a 3D printer construction which can produce a 3D printed model with a smooth and consistent finish. Because the 3D printer of the present invention may use layering of extrusions to produce a 3D printed model, in this context, a “high quality” or “highly smooth finish” or “consistent” may be defined as one which has less than 50 microns standard deviation between the calculated and actually achieved layer dimensions. This definition may be applied to the surface of the printed model formed by multiple successive layers, and in any of the coordinate axes, X, Y, or Z, which represent a Cartesian coordinate system as shown in FIG. 1. It is a further object of the present invention to achieve a smoothness of 20 microns standard deviation or less.

As can be appreciated by one in the art, a rigid frame and printing surface is necessary to achieve a highly smooth finish on a 3D printed model. Therefore base frame 101, internal body frame 102, and top frame 103 are passive (non-moving) elements and are preferably made by rigid injection molded plastic such as acrylonitrile butadiene styrene (ABS), glass-filled ABS plastic, polycarbonate (PC), ABS/PC, polyoxymethylene (POM), plastics, composites, or thermosetting (reaction injection molded) materials with flexural modulus greater than 250,000 PSI (at 73 degrees F.). The finished molded parts may be polished or painted thereafter. The present invention uses PC for the base frame 101, internal body frame 102, and top frame 103.

To maintain rigidity, base frame 101, internal body frame 102, and top frame 103 are connected by snap fits and screws which may be redundantly connected by some or all of the permutations of possible part interconnections. These permutations can comprise connections of: base frame 101 with both internal body frame 102 and top frame 103; internal body frame 102 connections with base frame 101 and top frame 103; and top frame 103 connections with base frame 101 and internal body frame 102. In addition, each part connection occurs at least two times, preferably through an identical and mirrored connections on the opposite side of the frame. The redundant connections provide additional rigidity, structural strength, and may reduce vibration and noise. Snap fits are preferred to maintain an exterior without holes for screws, however, an alternative embodiment allows for holes and screws to replace some or all of the snap fit connections. In the present invention, four base screws 160 hidden under the removable print bed 151 are used in conjunction with snap fits to hold internal body frame 102 to base frame 101. In FIG. 20, snap-fit pegs C and D can be seen, which connect base frame 101 and internal body frame 102, in addition to the use of base screws 160. FIGS. 20 and 21 also illustrate cantilever snap-fits F on base frame 101 and their connection point G on top frame 103. The combination of a rigid frame structure and redundant connections provide a 3D printer which can achieve the smoothness of printed models as set forth as an object of the invention.

Logo plate 104 and logo plate insert 105 are also passive components. Logo plate insert 105 is preferably made in the same material and finish as base frame 101, internal body frame 102, and top frame 103. Logo plate 104 is preferably injection molded as a transparent or translucent part, such as acrylic, polycarbonate, TPU, or TPE. The front facing surface of logo plate 104 is finished to function as a light diffuser when an internal logo light 112 shines onto it. This is achieved by sandblasting the surface, or painting with a matte-white paint. This gives a glowing long-ranging diffusion effect. In the present invention, the back of logo plate 104 is painted white and the front is molded with a sandblasted texture.

### General Frame Assembly Components

FIG. 3 also illustrates an external assembled view of an X guide rods 552, nozzle cover 813, nozzle 811, extruder front cover 872, and cable assembly 121. The connection between these parts and others in the assembly, as well as their function, is shown in other figures.

Now referring to FIG. 5, which illustrates an assembled back view of the 3D printer, a computer interface port 111b, and power port 111a are shown. In the present invention, electronic control board 111 is secured to base frame 101 with two base screws 160. The computer interface may use a USB cable (not shown) connecting computer interface port 111b to a PC, tablet, or other computer device with USB host function. The computer controls the 3D printer 1 via a live “drip-feed” of positioning code. The code is sent by the computer, through the USB cable, which connects to the electronic control board 111 through the computer interface port 111b. The electronic control board 111 connects to a power supply through power port 111a and an electrical power cable (not shown). The electronic control board 111 provides signals to control the motors, logo light 112, and a heating element 812. Signals from the sensor 859 are received by the electronic control board 111.

### General Lower Gantry Assembly Components

Now referring to FIG. 13, which illustrates a perspective view showing a lower gantry assembly installed on the base frame 101, and FIG. 10 which shows an exploded view of the same assembly. The lower gantry assembly provides Z and Y directional movement for the upper gantry assembly 4 (shown in FIG. 17).

In the base frame 101, the printer has a loose circular space in the center to house a filament roll 601. There is also room for the electronic control board 111 that controls the 3D printer. A multitude of supports in the base frame 101 and/or the internal body frame 6 may provide pathways for anchoring electronic wires, tubes, cables, and similar parts as is known in the art of making injection molded product enclosures.

The base frame 101 provides support for interference fit to the outer raceway of frame bearings 141. There are four frame bearings 141 fitted to the base frame 101, all of which are preferably ball or roller bearings. These bearings support the bottom of the threaded Z rods 501 and square Y rod 503 by a clearance fit between a rod and the bearing inner raceway, which allows for smooth rotation of the rods.

The base frame 101 also provides areas for interference fitting the motorY 134 and motorZ 133. MotorZ pulley 511 connects to the threaded motorZ rod 502 and the shaft of motorZ 133 by interference fits. Y-axis motorY pulley 512 connects to the square motorY rod 504 and the shaft of motorY 134 by interference fits.

Z belt 521 connects three Z pulleys 513 and one motorZ pulley 511. Y belt 522 connects motorY pulley 512 to Y pulley 514.

Both motorZ pulley 511 and motorY pulley 512 have the inner raceway of motor pulley bearings 142 press-fit onto the outside of the pulleys. The outer raceway is press fit into internal body frame 102. Motor pulley bearings 142 increases the rigidity and straightness of the Y rods 502 and motorY rod 504 that are attached to motor shafts through a pulley that is under tension from Z belt 521 and Y belt 522. The addition of motor pulley bearings 142 will prolong the life of the motorZ 133 and motorY 134, as well as allow for high print qualities.

The rods 501, 502, 503, 504 are preferably a rigid material with high tensile modulus, preferably 30,000 PSI or greater, such as stainless steel. Pulleys of type 511, 512, 513, 514 are preferably a moldable plastic material with moderate friction, such as glass-filled polycarbonate or glass-filled nylon or even Polyoxymethylene with a slightly rough surface.

### Lower Gantry Assembly Z-Movement Function

Referring to FIG. 10, FIG. 13, and FIG. 17: There are three rods of type 501 which are connected to the base frame 101 by frame bearings 141, and have a Z pulleys 513 press fitted to the shaft. Pulleys 513 and 511 have groves which are used to transfer rotational motion, and are preferably of the MXL or GT2 type design. Three rods of type 501 and one of type 502 have their rotation coupled through Z belt 521, which connect to the outside of three pulleys of type 513 and pulley 511 respectively. When the motorZ 133 rotates, the threaded Z rods 501 and motorZ rods 502 rotate in unison, causing the upper gantry 4, also known as an H-bridge, to move up or down along the Z-axis. Using the Z rods 501 and motorZ rod 502 to support the upper gantry 4 from all four corners creates redundant rigidity and support necessary to achieve higher resolutions and print qualities.

### Gantry Rod End Design Allows Loose Tolerances

The rotation of the top side of the rods 501, 502, 503, 504 are supported by frame bearings 141. These frame bearings 141 are compression fit from their outer raceways to the top frame 103. However, it is a critical feature of the invention that the rods 501, 502, 503, 504 have a clearance fit with the inner raceway of frame bearings 141. It is a preferred embodiment of the invention to use a clearance fit, which allows tolerances of +/−0.05 mm to +/−0.10 mm between the top frame 103, frame bearings 141, and rods 501, 502, 503, 504. Using a tolerance of +/−0.10 mm is an object of the invention because it allows a lower-cost design in production. The clearance fit also allows for rapid assembly and disassembly. To assist in rapid assembly, the tops of the rods 501, 502, 503, 504 are dome-shaped with a fillet radius of 0.5-1.5 mm. If the inner raceway of frame bearings 141 (connected to the top frame 103) are connected to the rods 501, 502, 503, 504 by an interference fit, they will generate substantially limiting friction and noise to allow operation of the printer, require very small tolerances of +/−0.025 mm or less between the box, bearings, and rods. Tight tolerances like these are not an object of the invention because they are very expensive in production and subject to failure with defects or damage from usage.

All four Z-axis rods will not be completely constrained in the Z direction as a consequence of using clearance fits between rods 501, 502 and frame bearings 141. This movement would degrade the print quality and induce noisy vibrations, were it not for the use of springs washers 505. The spring washers are small rings with tabs protruding radially along the inner diameter. The spring washers are thin, but made of a high strength material, such as spring steel or stainless steel. The spring washers have tabs bent into them, some angled upwards and others angled downwards, and are installed between a ledge on the top of rods 501, 502 and the frame bearings 141 that are installed in top frame 103. Assembly of the printer will bend the tabs in a non-permanent manner since the spring washer gets crushed between the rod ledge and the bearing. As a result, the spring washers can be used as a gap-filler for tolerance stack-up and prevent Z rods 501 and motorZ rod 502 from shifting up and down along the Z-axis. This feature is necessary for high-quality prints, but also accommodates the use of lower-cost loose tolerance parts. In an alternative embodiment, a rubberized coating is applied to the areas of rods 501, 502 that come in contact with frame bearings 141. The coating is deformed as the bearing is pressed in place, ensuring a tight fit between the two parts.

### Molded Bearing Interference Fit Design Allows Loose Tolerances

A critical feature of the invention, shown in FIG. 20, is a geometry as shown which can be used to provide an interference fit between a portion of the injection molded frames (base frame 101, internal body frame 102, and top frame 103) and the outer raceways of bearings and motors, such as motorZ 133, motorY 134, motor pulley bearing 142, and frame bearing 141. In FIG. 20, feature A is used for the interference fit of motorY 134 and feature B is used for the interference fit of frame bearing 141.

This design provides several features which allow for a loose tolerance (0.1 mm) molded material to be able to fit a bearing. First, there is a taper which allows the press fit to provide increasing resistance to compression as it is installed. Second, there are several asymmetrically placed protrusions which overlap the outer raceway position by as much as 0.1 mm. This asymmetric placement helps center the bearing in position as it is pressed in during assembly. In addition, the protrusions provide minimal surface area, so when a soft plastic like ABS is used to mold the frame, it can be pressed out of the way to make room for a tight interference fit, despite being made of loose tolerance. The protrusions also provide room for excess plastic that may be shaved off during the fitting processes to accumulate. This novel design allows an injection mold with tolerance of 0.1 mm to fit a bearing, whereas it is taught in the standard art for a press fit to a bearing to have a 0.005-0.050 mm tolerance in a part that interference fits a bearing.

### Lower Gantry Assembly Y-Movement Function

The motorY 134 drives motorY pulley 512, which is connected to square Y-axis motorY rod 504. The other square Y rod 503 has Y pulley 514 compression fitted to it. Y belt 522 connects to the outsides of the pulleys connected to Y rods 503 and motorY rod 504, coupling their rotation. This coupled motion of square Y rods 503 and motorY rod 504 is transferred to the upper gantry assembly 4.

### Upper Gantry (H-Bridge) Assembly General Function

Now referring to FIG. 17 and FIG. 18, which illustrate an assembled and an exploded perspective view of the upper gantry assembly 4. Two front gantry supports 531 and two rear gantry supports 532 each are respectively connected to a threaded Z rod 501 or motorZ rod 502 through threads vertically tapped inside each gantry support at the position where the threaded rods meet these supports. An alternative embodiment includes an internally molded or inserted metal nut to provide threads. The rotation of the threaded Z rod 501 or motorZ rod 502 results in vertical motion of the gantry assembly 4.

The front and rear gantry supports should be constructed of a durable, low-friction material such as Polyoxymethylene, Polyamide, or Ultra High Molecular Weight Polyethylene, so that the force required to move the Z axis is kept to a minimum and so that the internal threads are easy to machine and withstand wear from repeated usage. In an alternate embodiment, the front and rear gantry support are made of nylon 66, for even greater wear resistance of the internal threading.

### Z Movement Rod Threads and Diameter Design

In one embodiment the threading in front gantry supports 531 and rear gantry supports 532 are of type 8-32, and in another embodiment it is of type 8-24 or M5, and the threading of the rods 501 and 502 match. Although it may seem obvious at first that any threading could work, it is a critical embodiment of the invention to allow the use of low-cost components that allow for a high quality 3D prints. When an acme “leadscrew” rod is used, the most accurate type of rod, the costs are unacceptably high for the present invention, and the diameters are also too large. When a large diameter threaded rod is used, such as ⅜″, it is severely limiting to the present invention. The high rigidity of these rods due to their mass requires that they are perfectly straight—any imperfection in the geometric straightness tolerance (or “wobble”) would result in an unwanted shift in the upper gantry assembly position, which in turn would lead to very poor print accuracy or smoothness, and increased resistance to rotation of the rods, which could lead to a stalled motor condition. In addition, large diameter rods reduce the space efficiency of the printer, and demand exponentially more motor driving torque. Where more motor torque is required to turn these rods, the cost of the motors increases, and so does their power consumption, which increases the cost of electronics and power components, and becomes prohibitively expensive. For example, the torque increases proportional to radius of the rod. However, as the radius increases, the circumference of the rod increases as well, proportionate to two times radius (2*radius). Therefore the net friction on the rods increases by the friction times the lever action distance, or radius*2*radius=2*radius². Therefore it is critical to the invention that smaller diameter rods are used. Smaller diameter rods also flex more before they result in permanent deformation, allowing a 3D printer to be designed with looser tolerances and friction. Small diameter rods also cost less and weigh less, which is desirable as an object of the invention. However, if the threaded rod diameter is too small, the rigidity of the gantry would become weak, and the number of rotations required to achieve Z translational motion would increase significantly. For these reasons, we claim a 3D printer with the design of threaded rods where the threaded rod is preferably between 2 mm diameter and 6.35 mm, or more preferably between 3.0 and 5.0 mm, where the threads per inch are preferably between 12 and 60, and most preferably between 20 and 32. As it will be appreciated by one in the art, when a gantry is suspended by threaded rods, there must be at least 3 threaded rods to define the plane of the top gantry assembly. Therefore we claim these designs when there are at least 3 threaded rods, even though the picture shows 4 threaded rods, any number above 3 could be used.

### Upper Gantry Assembly Y Movement Function

Front gantry supports 531 and rear gantry supports 532 are connected to two identical Y guide rods 551 via pegs as part of said gantry supports as illustrated in FIG. 18. In this embodiment, it is critical that the pegs have a very light interference or are clearance fitted with glue on the pegs to the Y guide rods 551 to prevent expansion of the rods that would increase friction on the moving elements or result in the splitting of Y guide rods 551. An alternative embodiment a light interference fit for quick assembly using holes in the gantry supports.

Square Y rods 503 and motorY rod 504 have upper gantry drive pulleys 515 clearance fit to them. Pulleys of type 515 are preferably a moldable plastic material with low to moderate friction and good wear resistance, such as glass-filled polycarbonate or glass-filled nylon. Another possible material choice would be polyoxymethylene, which is the material used in the present invention. In this embodiment the tolerance of the fit between the upper gantry drive pulleys 515 and the square Y rod 503 and motorY rod 504 must be less than 0.05 mm, and more ideally less than 0.025 mm to minimize backlash while limiting friction; even so this design would wear over time, increasing backlash. Backlash occurs when the direction of rotation changes.

To provide linear motion, two identical upper gantry belts 523 are attached to upper gantry drive pulleys 515. When the motorY 134 rotates, the square Y rods 503 and motorY rod 504 rotate, and in turn the upper gantry drive pulleys 515 rotate. Upper gantry drive pulleys 515 have a square hole which allows the square Y rod 503 and motorY rod 504 to slide through said pulleys as the upper gantry 4 is moved up and down the Z axis. The purpose of this sliding is to allow the motorY 134 in the base of the printer to control the upper gantry belts 523, regardless of the position the Z axis of the upper gantry 4. This allows much more efficient use of the printer's volume for printing than if the motorY 134 was directly attached to the upper gantry.

One end of each upper gantry belt 523 is tensioned by wrapping them around upper gantry idler pulley 516 which are concentric with Z rods 501 and motorZ rod 502. Upper gantry idler pulley 516 has two flanges two retain the belt and an upper gantry bearing 517 press fit on either end. Upper gantry idler pulley 516 and the two upper gantry bearings 517 slide into the rear gantry support 532 and are kept in place from the tension of upper gantry belts 523. The Z rods 501 and motorZ rod 502 thread into rear gantry supports 532 and go through the upper gantry idler pulley 516 and the upper gantry bearing 517, but do not actually come in contact with the inner diameter of the upper gantry idler pulley 516 or the upper gantry bearing 517. The upper gantry idler pulley 516 and the upper gantry bearings 517 are constrained to stay with the upper gantry 4 as it moves up and down the Z axis via the gantry supports 532. In an alternate embodiment the upper gantry idler pulley 516 and the upper gantry bearings 517 replaced with a double flanged, grooved, or V-cut bearing. In order to retain the double flanged, grooved, or V-cut bearing into rear gantry support 532, the bearing would have a thin-walled tube press-fit into the inner diameter of the bearing, or the inner raceway of the bearing would be extended both ways in the axial direction.

Left slider 533 and right slider 534 are attached to upper gantry belts 523 securely using teeth built into the sliders which interlock with the teeth of said belts. In the design shown, the upper gantry belts 523 are an open loop to allow the assembly worker to thread the belt through a hole in front gantry support 531. The ends of upper gantry belts 523 are pressed into the interlocking teeth of left slider 533 and right slider 534 and secured with glue or small set screws. In an alternative embodiment, upper gantry belts 523 are a closed, continuous loop that is secured into left slider 533 and right slider 534 with glue or small set screws. In this embodiment, the front gantry supports 531 must have slot in them in order for the closed upper gantry belts 523 to be installed.

Left slider 533 and right slider 534 are preferably made of low friction materials such as polyoxymethylene (POM) or polytetrafluoroethylene (PTFE) such that they create little frictional resistance to motion of the Y axis. The current design uses POM as the material for left slider 533 and right slider 534. Left slider 533 and right slider 534 are also designed to snap onto Y guide rods 551 quickly and easily for assembly.

The design of said connection to Y guide rods 551 is such that it allows for poor tolerances in Y guide rods 551 by flexing to allow a loose interference fit. Even as material loss occurs on left slider 533 and right slider 534 due to friction with Y guide rods 551, the curved shape of the connections on left slider 533 and right slider 534 will continue to flex inwards and maintain contact with Y guide rods 551. The same concept is applied to the connection between motorX housing 801 and X guide rods 552. This allows an acceptable low-cost, tight-tolerance fit with respect to the imperfections of manufacturing and wear during usage, providing precision and low friction regardless, yielding a novel type of bushing or bearing geometry.—

X guide rods 552 are for support and sliding of the extruder 5 in the X axis. Said rods are attached to left slider 533 and right slider 534 using holes or pegs in the same way as described earlier that Y guide rods 551 are attached to front gantry supports 531 and rear gantry supports 532. When upper gantry belts 523 rotate, they rotate at the same rate since they are coupled through Y belt 522, located beneath the internal body frame 102. Said rotation causes left slider 533 and right slider 534 to move forward and backward along the Y axis. Said movement causes the entire gantry portion attached to left slider 533 and right slider 534, including X guide rods 552 and Y guide rods 551, to move along the Y axis.

Y guide rods 551 and X guide rods 552 are constructed of a rigid material which also has a low coefficient of friction with respect to the material used to make left slider 533 and right slider 534, as well as the portion of extruder 5 which slides on rods Y guide rods 551 and X guide rods 552. There are many acceptable materials such as stainless steel, carbon fiber, fiberglass, carbon fiber, glass reinforced polymer composites, brass, or aluminum. The preferred embodiment uses carbon fiber, which provides high rigidity, good dampening characteristics, low weight, and is very resistant to permanent deformation due to bending. Because carbon fiber is rigid, it also allows less material to be used, allowing us to maximize print area vs printer volume. Furthermore, carbon fiber rods have a low coefficient of friction when combined with sliders/bushings of Polyoxymethylene, PTFE or other plastic materials. The carbon fiber's rigidity contributes significantly to the print quality, portability of the printer, and the ability of the printer to maximize space, and is a novel design component. The carbon fiber rods may be constructed by weaving or pultrusion, where pultrusion provides a preferable design because the carbon fibers are oriented in the direction of motion, reducing friction.

### Gantry Space Efficiency Optimizations Achieve a Lower Cost Printer Design

It is an object of the invention to provide a low-cost 3D printer, and one way to achieve lower-cost is reducing the total volume and weight of the product. The gantry design presented in the invention is therefore critical to enabling a low-cost printer because it is much more space efficient than the prior art, and provides a large gantry movement range within a tight space. Specifically, the present invention achieves an X print range of 113 mm, a Y print range of 114 mm, and a Z print range of 113 mm, while the box frame is 186 mm per side in a cube shape. These component make use of over 50-60% of the available linear space. They take advantage of the fact that the distance from each edge of the box to the beginning of the linear motion range only require 36.5 mm for the X, 36 mm for the Y, and about 43 mm from the bottom and 30 mm from the top for the Z.

### Upper Gantry X Movement Function

Rack 553 is used by extruder 5 to move along the X axis as defined in FIG. 1 using MotorX 833 which has a shaft attached to pinion gear 821. When said motor rotates, pinion gear 821 rotates and causes the extruder assembly 5 to move left or right along the X axis. X guide rods 552 force extruder 5 to move straight and precisely along the X axis when pinion gear 821 moves said extruder assembly. In the same way, Y guide rods 551 force left slider 533 and right slider 534 to move straight and precisely along the Y axis when upper gantry belts 523 rotate together.

### Upper Gantry Y Movement Alternative Embodiment Using High Tolerance Split Pulleys

In this embodiment, the front gantry supports 531 uses the same style of split pulley as illustrated in FIGS. 22 and 23. The object of the upper gantry split drive pulley 518 is to account for loose tolerances of the square Y rods 503 and motorY rod 504, and the tolerance of the upper gantry split drive pulley 518, which can be made by injection molding, through the use of a design that incorporates split section H, as shown in FIGS. 22 and 23. The split section H is enlarged in FIGS. 22 and 23 for clarity purposes and preferably measures less than 1 mm in thickness. Upper gantry split drive pulley 518 is loosely fit within upper gantry bearing 517 such that if the split pulley expands or contracts due to inconsistencies in the thickness of square Y rods 503 and motorY rod 504, it has room to expand. Despite the loose fit, the belt tension of upper gantry belts 523 keep said split pulley's center location from changing significantly as the split pulley expands and contracts with changing thickness of the square Y rods 503 and motorY rod 504. The two flanges on the upper gantry split drive pulley 518 can be molded as part of the pulley design (as shown), or as a separate piece (not shown) for low cost manufacturing. The separate flange is held in place loosely between the upper gantry split drive pulley 518 and the upper gantry bearings 517. In addition, the split pulley design allows for the upper gantry belts 523 to be placed centered on the Y guide rods 551. This is visually appealing and also provided more balanced forces which increase the life of all gantry supports and sliders.

To prevent high friction on said square rods, upper gantry bearing 517 are used on either side of upper gantry split drive pulley 518 to balance the forces on either side of said pulley and transfer the forces from the pulley to the bearings and through the front gantry support 531 and Y guide rods 551. As a result, the forces on the square Y rods 503 and motorY rod 504 resulting from the tension of upper gantry belts 523 are greatly reduced. This minimizes the bending of the square rod due to tension of upper gantry belts 523, which would have resulted in inaccurate print dimensions.

In another embodiment for the upper gantry idler pulleys 516, only one upper gantry bearing 517 is used per each side of the gantry and said bearings are supported with a screw through the middle. Double-flanged pulleys are attached to the bearings using a compression fit and upper gantry belts 523 are wrapped around said pulleys.

### General Extruder Assembly Design

Now referring to FIG. 1, which illustrates an assembled perspective view of the 3D printer 1, including the extruder 5. The only extruder parts that can be seen externally from this view comprise the extruder body cover 871, extruder front cover 872, and braided cable cover on cable assembly 121. The extruder 5 moves in the X linear direction through internally supplied motion. The movement of extruder 5 is also controlled by the gantry assembly, which provides motion in the Y and Z linear directions. The extruder assembly also provides heat for the filament extrusion process, extrusion of filaments through internally supplied motion, position feedback measurement through sensor 859, and a heat generating conductive material with a linear temperature coefficient (heating element 812) to allow for indirect measurement of temperature from the electronic control board 111. The extruder 5 comprises the cable assembly 121, which has a mesh sleeve that protects and guides electronic wires (not shown) and a filament tube 120 inside it, while providing a single external material for aesthetics. Cable assembly 121 contains within it wires to power the heating element, motors, and may also include wires for position feedback sensing.

Inside of extruder 5 (FIG. 15), the electronic wires (not shown) and filament tube 120 of cable assembly 121 are retained in cable strain relief 123, which is PVC overmolded around the wires and filament tube 120. Extruder body cover 871 has a slot on the bottom in which fan 829 is glued or press-fit into place. Upper vents on extruder body cover 871 are used for both exhaust of heat and/or intake of cool air. A small gap between extruder body cover 871 and extruder front cover 872 allows for additional ventilation of extruder 5. Fan 829 is responsible for both removing excess heat from inside extruder 5, as well as quickly cooling the extruded filament as it is laid out layer-by layer to form a 3D-printed object.

The extruder body cover 871 holds the cable assembly 121 using a compression fit or glue on the cable strain relief 123. In an alternative embodiment, a grooved grommet or crimped metal band may be used to connect the cable assembly 121 to the extruder body cover 871.

The extruder assembly 5 is covered by an extruder body cover 871 and extruder front cover 872. The extruder front cover 872 has snap-fit hooks that latch onto extruder body cover 871 allowing for quick assembly and easy, tool-less access to the internals of the extruder. In an alternative embodiment, extruder 5 is covered with a single piece extruder body cover that snaps on from above onto motorE housing 851 and motorX housing 801. Extruder body cover 871 and extruder front cover 872 are injection molded parts which could be made of polypropylene (PP), high-density polyethylene (HDPE), polyamide 6 (PA6), or polyamide 66 (PA66). In this instance, the extruder body cover 871 and extruder front cover 872 are both made of PA6 blended with reinforcing glass fibers.

### Extruder Assembly X Movement Design

Now referring to FIG. 15, which illustrates the internal components of the extruder assembly 5, and FIG. 16, which illustrates an exploded view of the extruder assembly internal components. MotorX 833 provides linear motion along the X-axis for the extruder assembly as detailed in the earlier section titled “Upper Gantry X Movement Function”. MotorX 833 is preferably constructed of a 4-wire, bipolar, 2-phase, micro stepper motor with a gear reduction between 1:4 to 1:64, and more preferably 1:16. Preferably, the size of this motor is between 15 and 35 mm, and more preferably it is about 24 mm. MotorX 833 connects to the motorX housing 801 by an interference fit. MotorX housing 801 connects to the X guide rods 552 by two C-shaped guides that snaps around the X guide rods 552. In an alternative embodiment, X guide rods 552 are clasped between motorX housing 801 and an bottom cover plate (not shown) that are fitted together with screws or a snap fit. The C-shaped guides of motorX housing 801 serves as a linear bearing in the X-axis direction, and are therefore preferably constructed of a low friction injection molded material such as polyoxymethylene, polytetrafluoroethylene, or polyamide. Additionally, the geometry of motorX housing 801 may be designed to provide flexibility against an excessively tight linear bearing fit, such as by including slits or thin wall sections, allowing the extruder assembly to serve as a tight tolerance linear bearing. The flexibility of motorX housing 801 may lower the sliding friction between motorX housing 801 and X guide rods 552, as well as compensate for material loss from the wear of the plastic throughout the lifetime of the 3D printer 1, or poor tolerances in manufacturing.

### Extrusion System Design

After motorX 833 is installed into the motorX housing 801, the motorX housing is connected to the motorE housing 851 through an interference fit. Alternatively the parts may be designed to be connected with screws or snap fits. The motorE housing 851 may be diecast or CNCed out of a lightweight metal such as aluminum or zinc to provide heat distribution throughout the extruder assembly. It is also possible to construct motorE housing 851 by injection molding it out of a plastic, such as ABS. To provide extrusion of filament during 3D printing, motorE 835 is connected to the inside of the motorE housing 851 by a compression fit. The motorE 835 is preferably constructed of a 4-wire, bipolar, 2-phase, micro stepper motor with a gear reduction of about 1:16 to 1:64, and more preferably 1:64. Preferably, the size of this motor is between 15 and 35 mm, and more preferably it is about 24 mm.

Extruder gear bearing 846 is pressed onto extruder gear 865 and held in place by a compression fit into the motorE housing 851. Extruder gear bearing 846 is preferably a radial ball bearing with an inner diameter between 4 and 7 mm, and more preferably has an inner diameter of 7 mm. Extruder gear bearing 846 may have a thickness between 2-5 mm and an outer diameter between 7-12 mm. Extruder gear bearing 846 supports axial loads on the extruder gear 865 during filament extrusion, preventing flexing of the motor shaft, which ensures positioning accuracy of the motor shaft, which ensures a proper amount of force on the filament being extruded, and also extends motor life.

Filament bearing 842 is held into motorE housing 851 with an interference fit between the inner raceway of filament bearing 842 and a peg that is part of motorE housing 851. The bearing is preferably a radial ball bearing with approximately a 6 mm inner diameter, 3 mm thickness, and 10 mm outer diameter, though other sizes bearings may be used. As an alternative, the bearing may be held onto motorE housing 851 with the use of screw. The filament bearing 842 reduces friction during filament extrusion while also guiding the filament and keeping pressure against the motor shaft. Gear cover 861, which is made of a plastic with low friction and good wear resistance such as nylon or POM, covers the extruder gear 865 and filament bearing 842 and guides the filament 600 so it travels into internal nozzle tube 815. Gear cover 861 is secured with gear cover screw 862, which allows easy access for the user in the event of a clog or filament jam near the extruder gear 865.

In alternative embodiments, motorE 835 may have a custom knurled or hobbed shaft or may include an additional adapter containing knurling or hobbing to improve contact with filaments. This custom motor shaft that is capable of gripping filament would eliminate the need for using extruder gear 865 as a separate part from the motor. In this embodiment, extruder gear bearing 846 is pressed onto the shaft of motorE 835 and is preferably a radial ball bearing with an inner diameter between 3 and 7 mm, and more preferably has an inner diameter of 4-5 mm.

To provide heating for plastic extrusion during 3D printing, a nozzle 811 is installed by press fitting or screwing into motorE housing 851 (or, alternatively, into motorX housing 801). The extruder nozzle is a novel unitary design which provides four functions: It transfers and buffers heat from a low-power heating element 812 to the filament 600; it provides a nozzle hole at the bottom exit for filament 600 extrusion; it holds an internal nozzle tube 815; and it provides thermal isolation from the motorE housing 851. As will be appreciated by one in the art, the combined function of the extruder nozzle in a unitary nozzle is novel, unobvious, and is useful, and cannot be achieved by any combination of the prior art.

### Extruder Assembly Filament Guide Design

The internal nozzle tube 815 provides a surface for contact with plastic feedstock in the form of filaments or rods between 1 and 3 mm diameter, in which the plastic can be heated without sticking to the inside walls of the nozzle 811. It is connected to nozzle 811 as a compression fit and may also be physically constrained by motorX housing 801 and/or motorE housing 851 after installation.

In this embodiment, the internal nozzle tube 815 may only be constructed of a material with long-term resistance to creep under thermal loads of 230 degrees C., while also providing a slippery surface defined as having a coefficient of thermal expansion less than 0.2. If the friction coefficient is higher than this number, the filament will jam against the walls under its own pressure. While materials like graphite and wood may meet this requirement, they would be subject to brittle failure over time. Materials that meet this requirement therefore may comprise Perfluoroalkoxy (PFA), Polytetrafluoroethylene (PTFE), and Fluorinated ethylene propylene (FEP), and similar materials. The most preferable material is PTFE with an inner diameter between 2.0-3.0 mm, and an external diameter between 3.0-6.0 mm. The present invention uses an internal nozzle tube 815 with an inner diameter of 2.0 mm and a wall thickness of 0.75 mm.

### Extruder Assembly Low-Power Heating Element Design

A low-power heating element 812 is used to provide heat evenly around the nozzle 811. Heating element 812 is in the shape of a tube that is designed to fit around the cylindrical nozzle 811, contacting each other around all 360 degrees. It is an object of the present invention to provide a compact 3D printer, thus a low power heating element is needed, one that uses up to 12 volts and uses 5-15 watts of power, and most preferably only uses 5V or less and uses less than 10 watts of power, due to the compatibility of this power profile with supplies on the market. The heating element 812 may be produced by wrapping conducting wire around a core and coating it with ceramic pastes, such as alumina or zirconia, and firing gradually up to at least 225 degrees C. to prevent crack formation. It is preferably a tough material made from alumina or zirconia. Because the heat is provided evenly around the nozzle 811, which then conducts the heat evenly to the internal nozzle tube 815, the filament 600 will be heated more evenly during extrusion. This allows for more accurate prints with fewer jams, without the use of a high-power heating element. In the prior art, all nozzles are heated asymmetrically and not radially, which requires higher power heating elements in order to prevent jamming due to under-heated filament failing to extrude. It is preferable that the heating element wires are made of a material with predictable and linear temperature coefficient of resistance (TCR) within the range of 0.10*(10⁻³/° C.) to 10*(10⁻³/° C.), such that the temperature of the extrusion process can be measured in the heating element 812 indirectly by monitoring electrical current used by heating element 812 with the electronic control board 111 in the 3D printer 1. However, since it is an object of the present invention to use less than 15 W of power, and the heating element 812 uses preferably around 7 W at 230 degrees C., it would use too much power at room temperature to have a TCR greater than 5*(10⁻³/° C.) while meeting this 230 degrees C. constraint. However, if the TCR was less than 1*(10⁻³/° C.) it would require more sensitive (and expensive) voltage dividers and amplifiers to detect a change measurable by an analog-to-digital converter. Therefore, an ideal TCR material may include nickel, tungsten, copper, tin, zinc, silver, or aluminum, and most ideally uses either tungsten or nickel due to their ability to ensure oxidation at high temperatures for long periods of time. Heating elements of this type can be produced as is known in the art, such as shown in U.S. Pat. No. 6,169,275 B1, and U.S. Pat. No. 5,753,893 A. However, heating elements of this type are primarily optimized as oxygen sensors and not as tubular (radial) heating elements for filament extrusion. Since it is an object of the described invention to use tubular ceramic heating elements to melt filament within a 5-7 mm heated zone, while maintaining a short length of 9-12 mm, and providing a specific range of TCR element, and tubular structure with wall thickness of 1-1.5 mm, we have created a novel low-voltage heating element suitable only for use in the 3D printer of the present invention.

### Safe Printer Heating Element Design

It is an object of the invention to provide a “safe” 3D printer that cannot harm the user or endanger them through thermal runaway, which could lead to fire or off gassing of dangerous fumes. Therefore it is critical to the invention that thermistors are not used, and this is a novel design. Thermistors are traditionally used because they can provide accurate temperature readings without signal amplification, but only once they reach a high temperature. Thermistors add costs to a 3D printer, as well as a significant risk. The risks include breakage of the thermistor, which would void function, and could lead to a runaway thermal overload situation, which could be a fire hazard. In addition, a thermistor is typically mounted outside of the where the filament is actually heated. This distance of the thermistor from the actual filament melt zone results in inaccurate temperature measurements, which could lead to overheating of the filaments, poor or excessive printing layer adhesion, nozzle ooze, inconsistent printing temperatures, and poor responsive times to outside cooling or heating forces. By contrast, the indirect temperature reading of the heating element coils itself is a far more reliable, consistent, and direct measurement which dramatically increases reliability, consistency, and reduces the overall cost of the components needed to make 3D printer. In addition, it is a safety features that the heating element 812 is also the temperature sensing element, so it is impossible to overheat or cause a thermal runaway scenario.

### Heating Element Insulator Design Option

An alternative embodiment of the present invention may include a nozzle cover 813, which may: further reduce the power requirements of the low power heating element 812; may prevent the nozzle 811 from moving or vibrating out of position, thereby improving print smoothness; may reduce the risk of users getting burns from coming in contact with the hot nozzle 811; and may prevent extruded molten plastic from building up on the end of the nozzle over extended usage. The heat insulator needs to be able to handle 230 degrees C. over long periods of time while limiting heat conduction. It may therefore be made out of fiberglass laminates, silicone, mica, kapton, cellulose, and other insulating material. It may be bound in place by compression fitting or by glue, either to the heating element 812, nozzle 811, motorX housing 801, or motorE housing 851.

### Low-Power Unitary Extruder Nozzle Design

Referring now to FIG. 12, the nozzle 811 may be produced by a material with thermal conductivity between 1 and 100 W/mK. If the thermal conductivity is too low, it may not be able to transfer heat evenly or quickly, but if it is too high it will dissipate heat too rapidly, thus it is more preferable to have the nozzle a thermal conductivity between 5 and 30 W/mK. The nozzle material must be rigid enough to prevent flexing during printing, which would result in inaccurate prints. The material needs to be durable enough to prevent brittle fracture due to shock or pressure. Example materials that the nozzle may be constructed of that meet these constraints may include alumina, zirconia, stainless steel, carbon steel, and titanium, with the most preferable material being stainless steel 303 or 304. The nozzle exterior may be produced by turning processes, while the nozzle holes may be produced by drilling, wire cutting, or laser. Alternatively, the nozzle body may be produced by casting, sintering, or 3D printing processes with some post processing.

The nozzle exit hole may have a diameter between 0.25 and 1.0 mm. However, as the nozzle diameter is decreased, the number of manufacturing and 3D printer operational difficulties increase. For instance, the amount of undesired filament extrusion due to internal filament thermal expansion and gas generation which may reduce print quality, also known as “ooze”, increases exponentially with decreasing nozzle size. For example, a 0.25 mm nozzle would ooze at approximately four times the rate of a 0.5 mm nozzle based on volumetric expansion of plastic filaments, resulting in unintended extrusion on a 3D printed model edges. In addition, smaller diameter nozzles are extremely difficult to machine or machine accurately with reasonable concentricity and tolerances by traditional processes such as drilling. Specifically, it is challenging to drill holes in stainless steel or titanium below 0.35 mm due to the hardness of the material and the brittle nature of small drill bits. As a result, the only way to achieve smaller diameters would include drilling, which would have large failure rates; wire electrode discharge machining, which is expensive; and laser ablation, which is time consuming and expensive. Furthermore, during the 3D printing extrusion process, it is possible that latent dust, contaminant particles in the plastic filament feed, and even decomposed residual plastic may clog a nozzle, the chances of which increase exponentially with smaller nozzle orifice size. Finally, smaller extrusion diameters increase the pressure on the extruder motor, requiring more motor energy or higher gearing. However, larger sized nozzles above 0.5 mm may produce less desirable feature resolution. It is therefore most preferable when making the nozzle 811 to have a size range to at 0.35-0.5 mm. For similar reasons, it is preferable to have a minimum nozzle hole length of about 0.5 mm-1.0 mm.

It is important as set forth in this specification for the nozzle 811 to provide thermal conductivity and thermal buffering in combination with heating element 812 and internal nozzle tube 815 to the plastic extrusion. This is preferably achieved by a bottom portion of the nozzle having between 5.0 to 12.0 mm of length containing stainless steel with a wall thickness of about 0.25 to 0.75 mm. Due to the minimum outer diameter of internal nozzle tube 815, which is about 2.5-3.5 mm, the nozzle 811 inner diameter is limited to about 2.5-3.5 mm.

The outer diameter of the nozzle 811 is also limited because a larger diameter nozzle increases the thermal mass of the system and increases the heat lost due to convective surface effects, increasing the power requirements of the heating system, and decreasing responsiveness. However, as set forth in the ideal embodiment, a low power heating element is desired. Because of the minimum strength requirements of the heating element 812, the wall thickness of the heating element would be 1-2 mm. Through careful experimentation, it was discovered that heat dissipation became rapid above an external heating element diameter of 8.0 mm, necessitating a combination of a thermal break, a more powerful heating element, and also thermal insulation with nozzle cover 813 around the heating element 812 to allow temperature to reach at least 230 C (a temperature needed for the extrusion of ABS and other common plastic filaments). It is therefore desirable to keep the heating element 812 outer diameter below 8.0 mm, and this results in a preferred heating element 812 inner diameter of 4.0 to 6.0 mm. As a result, the maximum outer diameter of the stainless steel nozzle 811 must also be between 4.0 to 6.0 mm, and is most preferably between 4.5 and 5.5 mm. When taking into account the preferred wall thickness of nozzle 811, which is 0.25 to 0.75 mm, the inner diameter of the heat transfer region of nozzle 811 can only be between 2.5 and 5.5 mm, and it most preferably 3.5 mm.

Finally, it is critical as set forth in this specification that the nozzle 811 limits heat transfer towards the extruder gear along the path the filament 600 travels before being extruded. Excess heat will cause the filament to soften outside of the heat transfer region of the nozzle 811 which will cause filament jams. Thus, there must be a thermal break in the nozzle 811. The thermal break prevents heat transfer through the heating element nozzle by three means: it provides an elongated heat conduction path; it provides additional surface area for convective cooling; and it provides reduced thermal mass by reducing the amount of material heat can conduct through, which is achieved by having a thin walls. The wall thickness of the nozzle 811 above the heat transfer zone is between 0.15 and 0.30 mm, and in this embodiment they are 0.20 mm. It is preferable in this design that a combination of reduced heat flow area and elongated conductive path length are achieved.

In an alternative embodiment seen in FIGS. 24 and 25, holes J, staggered slots (not shown), or spiral cuts 24 are added in the thermal buffer zone of the nozzle. Further reducing the amount of mass and increasing the heat transfer path length should decrease the rate of heat transferred away from the heat transfer zone. For example, in spiral cut nozzle 809 a spiral section of 12.5 min length is provided. This section reduces the amount of surface area by about 40% to 60%, while increasing the conductive path travel length from about 12.5 to about 30.0 mm or 240%. Therefore the net impact of this geometry is calculated by [average new path travel length]/[average surface area reduction], or [240%]/[60%]=400%. This design therefore provides a 4-fold increase in the amount resistance to heat conduction, not accounting for convective effects or conduction through the internal nozzle tube 815. A similar example using perforated nozzle 810 shows a reduction in surface area and mass due to a plurality of holes, each with a diameter of 0.25 to 2.5 mm (2.0 mm, as shown). These designs were not chosen for use due to the complexities they add to manufacturing, as well as the decreased strength of the nozzle. The present invention uses nozzle 811, which has with 0.20 mm thick walls made of stainless steel and an internal nozzle tube 815 made of PTFE with 0.75 mm thick walls.

The observed effect of the thermal break is to reduce temperatures from about 230 degrees C. to less than 100 degrees C. (steady state) at the anchoring point in motorE housing 851, and more ideally to less than 60 degrees C. Any increase in the diameter or thickness of the nozzle 811 would both increase the amount of heat conducted to the anchoring point and increase the amount of heat dissipated by the heating element, violating the low power objective of the present invention. In addition it is desirable for 3D printer extruder nozzles to have a rapid thermal transition, reducing jamming of plastic in the nozzle due to the stickiness of plastic in a semi-molten state. While a larger diameter and larger powered heating element nozzle could be used, it would require a longer thermal break, which would be difficult to fit in a compact design and could require a more powerful motor to push the filament. It is therefore an object of the invention to provide a nozzle 811 with a length of 15 to 40 mm, and more preferably between 25 to 35 mm, which has a thermal break region of at least 5-10 mm.

By way of illustration of the advantages of the present invention as compared with the prior art, it can be seen that the present invention differs substantially from U.S. Pat. No. 6,004,124 by Swanson and Hopkins which describes a stainless steel extrusion nozzle, and there are at least four major differences, as follows:

In U.S. Pat. No. 6,004,124, a thin-walled stainless steel nozzle is used as both the heat isolation and heat conduction sections; by contrast in the present invention the addition of spiral cuts or holes to the nozzle, such as with spiral cut nozzle 809 or perforated nozzle 810, provide heat isolation and can easily accommodate thicker walled sections such as 0.5 mm, whereas the prior art example describes a maximum wall thickness of 0.381 mm.

Also, U.S. Pat. No. 6,004,124 teaches the use of the stainless steel as the surface in direct contact with molten modeling filament, whereas in the present invention a sleeve of PTFE (internal nozzle tube 815) provides direct contact with molten filament, reducing friction.

Furthermore, U.S. Pat. No. 6,004,124 describes the use of a heating element block with an independent heating element, whereas the present invention provides for a nozzle that is radially heated (that is, evenly heated from all sides) with an integral and evenly dispersed heating element.

Also, above-noted prior art example describes the transition of filament from a solid to a molten state while traveling through a thin-wall nozzle, whereas the present invention exclusively provides for the possible inclusion of thin-walled stainless steel sections only where the filament is solid and within the thermal break region.

Finally, the inclusion of PTFE internal nozzle tube 815 inside of nozzle 811 creates a double-wall design, where there is an inner wall made of PTFE and an outer wall made of stainless steel. In this design, there are no regions with a wall thickness that could fall in the thin-wall tube thickness range stated by Swanson and Hopkins of 0.2032 mm to 0.381 mm. Even at its thinnest point, which is in the transition zone, the present invention has a total wall thickness of 0.85 mm (0.20 mm of stainless steel, plus 0.75 mm of PTFE). In the heating zone of the present invention, the total wall thickness is 1.50 mm (0.75 mm of stainless steel, plus 0.75 mm of PTFE).

### Low Cost, Low-Power Input, High Torque and Speed Motor Design

Now referring to all the figures: In order to provide a 3D printer of relatively low cost, the present invention employs relatively low cost stepper motors, also called “microstepper motors” or “microstepper gearmotors” or “stepper gearmotors.” By contrast, at the present time other types of 3D printers use “NEMA 17” motors or similar hybrid style motors. Such motors are typically used because they have adequate power (500 g-cm or more torque) and speed (180 revolutions per minute) or more, with a minimum of backlash at the motor shaft, and motor life of thousands or tens of thousands of hours. However, such motors have relatively high costs, and even higher motor driver costs, control board heat dissipation costs, and relatively high power supply costs. They also take a relatively large space (over 30 mm per dimension) and have a relatively large weight. As a result, such motors (“NEMA 17” and similar hybrid style motors) are severely limiting for the application of a low-cost, low-power 3D printer. As an alternative, one 3D printer uses a servomotor design, which includes a DC motor and an encoder for position feedback. However, these motors can generate a lot of noise, are expensive, have different system dynamics which increase costs and limit printing capabilities, do not output as much holding torque or low-speed torque as a stepper motor of the same size, and can have limited lifespan compared to stepper motors.

The smaller motors are necessary in order to maintain the space efficiency of the present invention. In the base of the printer, which holds motorZ 133 and motorY 134, enlarging the motors would result in either a reduction in print volume or a larger printer with the same print volume dimensions. The smaller motors are especially important in the extruder, where space is severely limited. Increasing the size of motorX 833 and/or motorE 835 would require a larger extruder cover 871. The size of the extruder directly relates to the print volume, so a motor size increase in the extruder results in losses in the print volume in the X, Y, and/or Z directions.

Therefore, to maintain the object of the invention, which is to make a low cost, low-power 3D printer, the present invention provides a new kind of micro stepper motor. The micro stepper motors of the present invention are preferably of the same design. They are an improvement on existing micro stepper motors (style BYJ, or BYHJ) which are currently used in positioning or motion systems for scanners, IP web cameras, air conditioner louvers, and paper feeders. As they are used in the prior and present art, these motors are typically used as a single-direction motor because they are geared highly to provide enough force, which results in a backlash of about 3-10 degrees. These motors have a gearbox coupled directly to them, which is essential to achieve the desired output forces, which typically require 500-5000 g-cm of torque. Thus, the mini stepper gearmotors of the prior art have a resistance of 30-300 ohms per motor winding, are typically geared 1:10 to 1:200, and most can only move at most 60 revolutions per minute (RPM). These characteristics are very far from those needed for a 3D printer of reasonable performance and when combined with backlash have been completely prohibitive for the application as a rapid moving gantry element. Moreover, the motors of the prior art are most often configured as unipolar, which reduces the cost and complexity of control electronics, but further reduces the motor torque. Thus the motors of the prior art are only used in very low power, slow moving, single direction, high torque applications.

In the present invention, a micro stepper motor is shown having completely different characteristics than the prior art. Using the same basic principles of the prior art as a starting point, the present invention provides a micro stepper motor with gearing. However, combined with electronic control and omnidirectional position feedback sensing, the present invention has substantially eliminated the problem of backlash, made the motors several times faster, made the motors output several times more torque, and eliminated the problem of overheating when motor winding resistance is lowered. The motors of the prior art, which are well known and can readily be researched and purchased online, are available in 1:16 gearing and are run at 5V to obtain a maximum holding torque of 150 g-cm and a max speed of 25 RPM. With the modifications of the present invention in place, tests have proved that the present invention motors can achieve over 460 g-cm holding torque and max speed of 200 RPM with a similar size motor with the same gearing. This equates to tripling the holding torque of the motors of the prior art and increasing the max speed by a factor of eight.

The motors of the present invention are micro stepper motors with gear reduction. Typically they are of the “24BYJ48” type design, though they may be varied to have their gearing actuated at a distance instead of having an integrated gearbox. The motor will have a size of 8-35 mm diameter and about the same dimension range in height. The gear ratios vary from 1:4 to about 1:128. To increase the speed and torque of the motors, the motors should be in a bipolar two-phase winding configuration. The resistance of each phase of the motor should be between 0.5 ohms and 30 ohms. For low-noise applications, resistances near 30 ohms are preferred. In instances where the maximum amount of power is needed, the resistance of each of the phases should be closer to 0.5 ohms.

As a result of using the techniques of the present invention, the inventors have greatly improved the characteristics of micro stepper gear motors, making them suitable for use in many types of applications that were previously not possible.

### Motor Electronic Control System for Maintain Power Consumption Levels

To address the issue of motors overheating overall due to the higher current consumption, the present invention provides firmware and electronics on the onboard electronic control board 111, which meters current. The present invention uses the fact that at high speeds, the motors' internal resistance increases due to back EMF and inductance limit maximum current. In order to achieve maximum speed at reasonable torque, the motor electronics must have no current limiting. However, at lower speeds, current would increase dramatically, causing the motor windings to overheat. Therefore, the motors of the present invention must be coupled to a control system which can reduces the current supplied to each of the motor windings at slower speeds, maintaining torque across these varying and lower motor speeds, providing lower power consumption, and reducing heating at slow speeds. When calibrated, the motor and control system of the present invention can maintain a lower motor operating temperature while providing unprecedented motor speed and torque from a small package.

### Motor Backlash Compensation System Design

To address the issue of microstepper gearmotors having 3-10 degrees of backlash, others have provided anti-backslash springs and follower systems (two coupled motors). However the inventors have found in reduction to practice that these systems do not solve the problem fully, and they create excessive wear on the motors in one direction, causing premature failure of the sensitive motor gears. They also create excess force in one direction and limit force in the other direction, necessitating more powerful motors. In addition, the amount of force needed in follower and spring systems can change over time, due to wearing of components in the system.

The present invention provides a novel system solution to solving backlash in microstepper gearmotors. The motor control electronics in electronic control board 111 has firmware written into it that provides backlash compensation. This solution is relatively complex, having to take into account that 1) backlash varies differently in each dimension, possibly due to asymmetries in gear profiles during production and/or other factors, and 2) the backlash can differ by batch, over time due by the amount of internal motor wear, and over time as external shaft friction changes. It would therefore be impossible to create a one-time backlash calibration, and a symmetric backlash adjustment would not be as ideal as using one number for each direction on each axis. The present invention provides a low-cost position feedback sensing element 859 (“backlash detection sensor” 859) which when coupled with backlash compensation firmware can recalibrate the backlash prevention at any interval—this could be one-time calibration in the factory, monthly calibrations, calibrations before or after each 3D printed model is made, or even in real-time when printing is performed. All the backlash calibrations can be performed independent of user feedback (such as before each print) or it can be initiated by a user on demand.

The backlash detection sensor of the present invention uses the sensor 859 which is an accelerometer or vibration detection switch to sense jerk or acceleration when the extruder assembly 5 is moved in the X, Y, or Z direction. The sensor 859 is preferably placed inside the extruder assembly itself. The force detection is in the range of 0.1 to 10 standard gravity's (“g's”). The electronic control board 111 sends motion pulses to the stepper motors, and the backlash sensor of the present invention detects if there is motion, and even the intensity of the motion. For example, 10 stepper motor movement signal may be sent, microstepping a motor for a total of 0.3 mm of motion, the entirety of which may result in zero travel movement due to backlash in this example. On the 11^{th} pulse, a significant jump in motion can be detected as backlash may have been overcome, and upon successive pulses the feedback signal intensity may reach a maximum or plateau. This information can be used to detect the exact distance of backlash needed for recovery from backlash and in each direction based on calibrations of the motor output shaft size to determine the exact amount of backlash that a motor pulse signal correlates with. This can be repeated on each axis, and for both directions of motions in the X Y and Z directions. The calibration procedure can be repeated multiple times, and the median result can be taken to eliminate noise from outside forces.

In an alternative embodiment, 3D printer 1 comprises of X, Y, and/or Z axis linear guide rails containing a proximity sensor for detecting relative displacement. This proximity sensor could be an optical encoder or capacitive displacement sensor. A standard calibration could set the zero locations of the printer and measure backlash as a one-time calibration in the factory, a series of monthly calibrations, and/or calibrations before or after each 3D printed model is made. While the 3D printer is in motion, feedback from the sensor could be sent to electronics control board 111 to give the location of the printer. Backlash could be detected and compensated for by measuring the actual distance traveled after a command is sent that tells the printer to move a specified amount. The difference between the specified travel distance and actual travel distance would be the amount of the backlash that the backlash compensation firmware must account for.

### Motor Z-Level Sensor and Bed Planarity Calibration Design

In addition the same sensor 859 may be used to replace the need for endstops which ordinarily determine the limits of the gantry, by sensing motor stalling indirectly when motors crash into the X, Y, or Z limits of the print volume. The same sensor 859, or a tilt sensor, may also be used to level the Z gantry, and in addition can be used as a bed leveling system. Bed leveling is a critical problem with the prior art of 3D printing, because without a level bed, often within 0.05 mm tolerance, 3D prints can start poorly, warp, deform, or even lift off the bed, frustrating the user. The backlash detection sensor 859 of the present invention can be used to “Crash” the nozzle into the print bed 151, detecting the crash jerk or deacceleration, or it can be used to direct motor vibration from afar. For example, motors in the printer casing, such as motorY 134 and motorZ 133, could be turn on maximum current to generate vibration signals, or a vibration element could be placed inside the printer body to allow this detection to occur. When the sensor 859 is not touching the 3D print bed, it will detect a lower vibration signal than when it is in direct contact with the print bed coupled through mechanical structure to a vibration generating source, allowing a point of contact level determination. This Z level detection can be repeated on at least 3 points on the plane of the print bed to determine its planarity, and the firmware on the electronic control board 111 would adjust the print to compensate for a non-leveled print bed plane (relative to the gantry X Y plane). The same system may detect the Z level of the print bed at the print start location.

Of note, the print bed and autocalibration and motor systems of the present invention are a significant improvement on the prior art. Bed leveling systems are often manual and require great efforts to maintain. For example, in the prior art screws are used to level a print bed, and due to vibration in the motors, the screw loosens and causes the level to change repeatedly during usage. In the present invention, the use of microstepper motors and lower power consumption dramatically reduces vibration and noise, which helps to maintain the level or alignment of system components such as the print bed and gantry. In addition, the printer of the present invention uses mainly snap fits, which also ensure that the positions of components are held rigid and do not change overtime.

### Significantly Improved Print Qualities

The inventors have also found that as a result of these detailed calibration procedures, the present invention can achieve more smooth and accurate 3D printed models than high-end 3D printers of the prior art. This may be because the printers of the prior art assume that without a gear reducer or gearbox there is minimum backlash, and the problem is ignored. However, the 3D printers of the prior art often have 0.05 to 0.2 mm backlash due to flex in components or tension in timing belts, and this backlash can increase dramatically over usage as there is no backlash compensation in these systems. Thus the present invention represents a significant improvement on the prior art in that it recognizes backlash as an initial and increasing problem during usage and provides means for compensating for this backlash, greatly improving both 3D print accuracy and useful 3D printer lifetime.

### Novel Zero-Power Print Bed Design

In the prior art, 3D print beds use glass and a heating element to promote adhesion of the first layer of ABS to a print bed. In some prior art embodiments, a PCB is used to provide anchor holes that are filled by the 3D printer, and in other embodiments glue or solvent dissolved ABS is applied to a print bed to promote adhesion of the first print layer. These prior art solutions can be inconsistent, frustrating to the user, messy, and/or consume power. The present invention and the following discussion is not limited to ABS however, and this may be interchangeable with other plastics such as PLA or nylon or polypropylene for example.

The present invention provides a zero power print bed solution. It use an ABS print bed with 0-30% glass or fiber or particle filling. This allows the initial layer of 3D prints to stick to the ABS bed, with the strength of the bond being determined by: (1) the orientation of the 3D printed plastic versus the orientation of the ABS polymer chains in the ABS print bed, (2) the temperature of the printed extrusion, (3) the distance between the printed extrusion and the print bed, (4) the amount of glass or particle filling in the ABS print bed, and (5) the amount of glass or particle filling in the ABS filament being printed.

Uniquely, the present invention provides that since the print bed can be “leveled” with software corrections to unprecedented accuracy, down to 0.05 mm, and more ideally below 0.025 mm, that the print layer distance can be adequately controlled (i.e. Z layer distance control) with a greater degree of accuracy than the prior art. This allows the printer of the present invention to print an initial ABS layer that sticks to a pure ABS print bed strongly, but not so strongly that it cannot be removed post printing. The ABS is most ideally printed as a 0.1 to 0.2 mm thick layer with a nozzle distance of 0.1 mm to 0.2 mm thickness and an error of less than 0.05 mm standard deviation in layer height and an actual plastic extrusion temperature of about 200-230 degrees C. The present invention also provides a unique provision for the use of the 100% ABS print bed as described over usage. As the print bed is used, the surface layer is consumed and becomes a rougher surface that is also more compatible with the exact polymer that the 3D printer uses, because the print bed surface and plastic extrusion are mixed at the interface, and separated at the end of 3D prints. Therefore, the 3D print bed must have its initial layer height increased approximately 0.025 mm per print up to as much as a 0.2 mm increase to compensate for the increase in bonding strength of the ABS print bed surface. After several dozen or hundred prints, the print bed may be flipped over to provide a fresh surface, or a new print bed may be used, whereby the user needs to indicate this fact to the control software and/or electronic control board 111 to reset the initial layer height distance.

Novel Zero-Power Print Bed and/or Filament Component Design

In addition the present invention may use a print bed with at least 5% glass filling to promote the preservation of the ABS print bed through usage and limit (or eliminate) the increase in initial layer height required to maintain consistent print bed and plastic extrusion bonding. ABS plastic may be increased to as much as 50% filler concentration when the fibers are long and oriented, such as with glass filling, as is known in the art. In addition, higher concentrations of glass filling assist in maintaining the rigidity of print beds, to prevent the 3D printed model from warping the bed during usage. A small amount of TiO2 (titanium dioxide) powder filling can also achieve the desired effect. For example, the addition of 1% or 5% TiO2 to the ABS print bed (instead of glass fibers) and prevent bonding and wear of the ABS print bed. In addition, 0.025%-1% TiO2 may be added to plastic filaments, and more ideally 0.05-0.25% TiO2 may be added to the plastic filaments to prevent their bonding to a print bed. This also promoted better removal of support from 3D printed models. In addition, 0.5%-5% pigments, including thermochromic pigments may be added to the plastic filaments to prevent them from bonding to the print bed. The print bed of the present invention may be connected to the internal body frame 102 using magnets in the print bed or printer frame, and magnets or metal in the opposite component.

### Reduced Noise Emissions

In order to create a quieter 3D printer, such as one suitable for an office or school environment, the prior art teaches towards using large enclosures to completely contain the 3D printer and muffle the noise generated by said 3D printer. The prior art teaches away from using an open enclosure in cases when noise emissions must be kept to a minimum.

The present invention has drastically lower noise emissions than the prior art. However, this is not due to the inclusion of an enclosure that seals off the sound generated by the 3D printer. Although such an enclosure would further reduce the noise emissions of the present invention, the present invention is already suitably quiet enough for use in a low-noise environment because it does not generate loud sounds. In a quiet office with 37-38 dB of noise, noise emissions from the present invention were measured while the present invention constructed a 3D printed model. At six inches from the extruder 5 on 3D printer 1, the noise emissions measured 39-58 dB. At three feet away from 3D printer 1, the noise emissions measured 38-43 dB. Finally, at six feet away from 3D printer 1, the noise emissions measured around 37-40 dB.

The primary contributing factor for the reduced noise emissions are the low-power micro stepper motors. These motors generate considerably less noise than the NEMA 17 stepper motors used in the prior art. In addition, while the printer itself has an open design so users can easily access their 3D printed models, all of the motors are contained within enclosed spaces to further reduce noise emissions.

While the micro stepper motors may be the primary contributing factor for the reduced noise emissions, there are other hardware design elements which also contribute to the low-noise design. The low-power heater and nozzle designs do not necessitate large, powerful fans or multiple fans, as seen in the prior art. Instead, a single 25 mm fan 829 supplies the extruder 5 with enough cooling power without contributing high noise levels.

The printer frame and motion control for the X, Y, and Z axes are also relatively silent. Low-friction linear guides (X guide rod 552, Y guide rod 551) dampen vibrations and allow for practically silent movement on the X and Y axes when coupled with the polymer linear bearings (left slider 533, right slider 534, and motorX housing 801). Likewise, the Z axis threaded rods (Z rod 501 and motorZ rod 502) move silently through the polymer threads in front gantry support 531 and rear gantry support 532. In addition, the Z belt 521, Y belt 522, and both upper gantry belts 523 transmit motion to polymer pulleys with minimal noise produced. Along the X axis, motion is transferred through a rack 553 and pinion gear 821 system. Metal rack and pinion systems are known for generating large amount of noise from the teeth chattering against each other, but the present invention uses nylon 66 as the material for both rack 553 and pinion gear 821 to reduce the amount of noise generated. Overall, the rigidity of the printer frame (base frame 101, internal body frame 102, and top frame 103) contributes to the reduction of noise-inducing vibrations throughout the 3D printer 1 as a 3D model is printed. In all cases, the coupling of components made of rigid materials (such as motors and steel threaded rods) with vibration-dampening materials (such as carbon fiber and polymers) allows for an overall reduction in noise emissions.

High quality prints are also the result of reducing the resonance of the upper gantry system 4 and extruder 5. Much of the prior art uses large, rigid, and heavy components that create vibrations when a motion-axis changes direction quickly (while printing a 3D printed model). These direction changes, which are frequent as the extruder follows the predetermined motion path, generate vibrations that can result in poor quality 3D printed models.

The use of light-weight micro stepper motors, typically 20-40 g per motor, means that the extruder 5 (which contains both a motor for the X axis movement and the filament extrusion) only weighs up to 150 g. NEMA 17 stepper motors in the prior art weigh anywhere from 150 to 500 g, and are typically over 200 g. Using motors of the prior art, it is physically impossible to design an extruder that weighs under 150 g and contains two NEMA 17 motors. As a result, 3D printers of the prior art either have an excessively heavy extruder, which causes undesired vibrations during the printing process, or the motion-axis motor and/or filament extrusion motor are not located on the extruder. In both cases, the print quality is lowered. Moving the X axis motor means more backlash can be induced on along the X axis and moving the extrusion motor forces the printer to use the less-desirable “Bowden-style” extruder—one where the extruder motor pushes the thin strand of filament through filament tube 120, rather than pulling on it. The present invention uses an extruder that weighs 125 g, contains one motor for filament extrusion, and contains a second motor for movement along one axis.

To further reduce resonance and create high-quality 3D printed models, the present invention uses materials that dampen vibrations. The use of a polymer, such as nylon 66 or POM, as the material for connecting parts of the upper gantry 4, including front gantry support 531, rear gantry support 532, left slider 533, and right slider 534, greatly reduces vibrations. This is explained in the section Reduced Noise Emissions, where these vibrations are regarded as a negative aspect of a 3D printer because of the noise they produce. In addition, the use of carbon fiber for the construction of X guide rods 552 and Y guide rods 551 further improves the quality of 3D printed models. Carbon fiber allows for greater energy dissipation in a vibratory system, while still exhibiting the high stiffness necessary to keep the extruder stabilized.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A 3D printer apparatus having low noise, comprising:
a casing;
a nozzle for printing, an extruder, and a print bed;
said casing enclosing a region above and around said print bed to form a printing zone;
a heating element; and
a plurality of motors for controlling movement of said nozzle during printing; wherein said plurality of motors have reduced noise.

2. The 3D printer apparatus of claim 1, further comprising a single relatively quiet low power fan for cooling.

3. The 3D printer apparatus of claim 1, wherein said heating element is a low-power heater requiring lower fan cooling.

4. The 3D printer apparatus of claim 1, further comprising a Y motion split pulley adapted to reduce backlash and friction.

5. The 3D printer apparatus of claim 1, further comprising a Y motion slider adapted to reduce friction and adapted to enable high manufacturing tolerances.

6. The 3D printer apparatus of claim 1, further comprising bearings, and wherein said casing has a high-tolerance injection moldable design enabling interference fitting of said bearings.

7. The 3D printer apparatus of claim 1, further comprising a gantry Z threaded rod motion system with a plurality of rods having diameters in a range of 3.0 to 5.0 mm, and having threads ranging from 20 to 32 threads per inch; wherein said plurality of rods includes at least three threaded rods.

8. The 3D printer apparatus of claim 1, further comprising an ultra-compact extruder assembly mounted in said extruder housing.

9. The 3D printer apparatus of claim 1, further comprising a low power heating element.

10. The 3D printer apparatus of claim 1, which uses 5 to 20 watts of power during operation, and further comprises a heating element operating at a power of 5 to 15 watts and motors operating at a power of 1 to 5 watts each; and having a zero power 3D printer print bed solution for adhering to ABS and similar plastics as the print bed.

11. A nozzle for use in 3D printing, comprising:
a nozzle body;
a nozzle hole;
said nozzle body having a thermal buffering region having an inner diameter and an outer diameter; and
a thermal break region; wherein said nozzle requires less heating power during operation.

12. A nozzle for use in 3D printing as claimed in claim 11, further comprising an insert member composed of PTFE tubing.

13. A nozzle for use in 3D printing as claimed in claim 11, wherein said nozzle body has a thermal conductivity in a range of 5 to 30 W/mK, a nozzle hole size in a range of 0.25 to 1.0 mm, said inner diameter of said thermal buffering region having a thickness in a range of 2.5 to 3.5 mm, and said outer diameter of said thermal buffering region having a thickness in a range of 3.8 to 5.0 mm.

14. A 3D printer apparatus, comprising:
a casing;
a nozzle for printing and a print bed disposed within said casing;
said casing enclosing a region above and around said print bed to form a printing zone;
an extruder housing;
a plurality of low friction linear guides adapted to reduce friction, dampen vibrations and reduce noise; and
a plurality of micro motors for controlling movement of said nozzle during printing.

15. A 3D printer apparatus as claimed in claim 14, wherein each of said plurality of micro motors has a resistance in a range of 0.5 to 30 ohms.

16. A 3D printer apparatus as claimed in claim 14, further comprising a motor control system for controlling said plurality of micro motors to maintain their temperature by running them at high speeds, and said motor control system controlling said plurality of micro motors using current control only at low speeds.

17. A 3D printer apparatus as claimed in claim 14, further comprising a motor control system having a backlash control means, wherein said backlash control means controls system axes backlash by compensating with software and includes an autocalibration subroutine that uses at least one of vibration sensing and acceleration sensing to measure an amount of backlash, and
for improving print quality by actively monitoring backlash properties.

18. A 3D printer apparatus as claimed in claim 14, further comprising a print bed having a Zero Power Print Bed Solution, wherein said print bed is adapted to bond models semi-reversibly, said print bed being composed of ABS with a carefully calibrated bed level and starting extrusion layer height when modeling with ABS.

19. A 3D printer apparatus as claimed in claim 18, wherein said print bed includes particles composed of at least one of TiO2 and glass fiber, for reducing adhesion between said print bed and the model.
